(19) United States
(12) Patent Application Publication
(10) Pub. No.: US 2026/0074940 A1
(43) Pub. Date: Mar. 12, 2026

(54) DISCRETE FOURIER TRANSFORM OF A PHYSICAL DOWNLINK CONTROL CHANNEL

(71) Applicant: InterDigital Patent Holdings, Inc., Wilmington, DE (US)

(72) Inventors: Sanjay Goyal, Deer Park, NY (US); Hussain Elkotby, Conshohocken, PA (US); Pascal Adjakple, Great Neck, NY (US); Umer Salim, Vallauris (FR); Ravikumar Pragada, Warrington, PA (US); Javier Lorca Hernando, Madrid (ES); Allan Yingming Tsai, Boonton, NJ (US)

(73) Assignee: InterDigital Patent Holdings, Inc., Wilmington, DE (US)

(21) Appl. No.: 19/106,031

(22) PCT Filed: Aug. 22, 2023
(86) PCT No.: PCT/US2023/030815

§ 371 Date: Feb. 24, 2025

Related U.S. Application Data
(60) Provisional application No. 63/399,839, filed on Aug. 22, 2022.

(51) Int. Cl. H04L 27/26; H04L 5/00

(52) U.S. Cl. CPC H04L 27/26524; H04L 5/0019

(57) ABSTRACT

Described herein are systems, methods, and instrumentalities associated with wireless communications using single carrier waveforms. A wireless transmit/receive unit (WTRU) as described herein may receive configuration information that may indicate a control channel element (CCE) and a plurality of resource groups associated with the CCE. Each resource group may include a respective time resource element (TRE) and a respective frequency resource group (FRG), wherein each respective TRE may include a non-integer number of time units, and each respective FRG may include multiple frequency units. The WTRU may determine that the CCE may be associated with a downlink control channel transmission, and further determine allocation pattern information associated with the resource groups in a search space. The WTRU may receive the downlink control channel transmission based on the determined allocation pattern information and receive a downlink shared channel transmission based on information in the downlink control channel transmission.

### CROSS-REFERENCE TO RELATED APPLICATIONS

This application claims the benefit of U.S. Provisional Application No. 63/399,839, filed Aug. 22, 2022, the contents of which is incorporated by reference herein in its entirety.

### BACKGROUND

Mobile communication technologies continue to evolve. The frequency bands used by a communication system may be in a high frequency range, which may create challenges for coverage and/or energy efficiency. The challenges may become greater if an input signal exhibits a high peak to average power ratio (PAPR). Adoption of waveforms and/or transmission channels that may address these challenges may be desirable.

### SUMMARY

Described herein are systems, methods, and instrumentalities associated with wireless communications using a single carrier waveform. A wireless transmit/receive unit (WTRU) as described herein may include a processor, and the WTRU may be configured to receive, from a network device, configuration information that may indicate at least a control channel element (CCE) and a plurality of resource groups associated with the CCE. Each resource group associated with the CCE may include a respective time resource element (TRE) and a respective frequency resource group (FRG), wherein each respective TRE may include a non-integer number of time units, and wherein each respective FRG may include multiple frequency units. The WTRU may be further configured to determine that the CCE may be associated with a time division multiplexed (TDMed) downlink control channel transmission, and further determine, based on the configuration information, allocation pattern information associated with the plurality of resource groups, wherein the allocation pattern information may indicate respective locations of the plurality of resource groups in a search space. The WTRU may receive the TDMed downlink control channel transmission in accordance with the allocation pattern information associated with the plurality of resource groups, and receive a downlink shared channel transmission based on information in the TDMed downlink control channel transmission.

Each respective TRE as described herein may include a non-integer number of orthogonal frequency division multiplexing (OFDM) symbols, and each respective FRG as described herein may include multiple sub-carriers (e.g., the multiple sub-carriers may be associated with a single discrete Fourier transform (DFT) module). The WTRU being configured to receive the TDMed control channel transmission in accordance with the allocation pattern information associated with the plurality of resource groups may include the WTRU being configured to locate the respective TREs and the respective FRGs of the plurality of resource groups in the search space based on the allocation pattern information and perform an inverse discrete Fourier transform (IDFT) based on the respective TREs and the respective FRGs of the plurality of resource groups. Each respective TRE as described herein may correspond to an output sample of the IDFT.

The configuration information described herein may further indicate a CCE aggregation level, and the WTRU may be configured to determine that the CCE is associated with the TDMed downlink control channel transmission based on at least one of a hash function or the CCE aggregation level indicated by the configuration information. The configuration information may further indicate one or more of a control resource set (CORESET) format, a number of FRGs in the search space, a size of the FRGs in the search space, or an indication that time division multiplexing may be applied to the downlink control channel transmission.

The WTRU being configured to receive the downlink shared channel transmission based on the information in the TDMed downlink control channel transmission may include the WTRU being configured to decode downlink control information (DCI) included in the TDMed downlink control channel transmission and determine resources for receiving the downlink shared channel transmission from the decoded DCI. The WTRU may be further configured to send a report to the network device that may indicate one or more of a number of DFT modules supported by the WTRU, a size of a DFT module, a number physical downlink control channel (PDCCH) transmissions that the WTRU may be capable of decoding in a symbol, a slot or a serving cell, or a number of non-overlapping CCEs supported by the WTRU.

A network device (e.g., a base station) as described herein may include a processor, and the network device may be configured to transmit configuration information to a wireless transmit/receive unit (WTRU), wherein the configuration information may indicate at least a control channel element (CCE) and a plurality of resource groups associated with the CCE. Each resource group associated with the CCE may include a respective time resource element (TRE) and a respective frequency resource group (FRG). The respective TRE may include a non-integer number of time units, while the respective FRG may include multiple frequency units. The network device may be further configured to transmit a downlink control channel transmission based on time division multiplexing and using the plurality of resource groups associated with the CCE, wherein the downlink control channel transmission may include resource allocation information for a downlink shared channel transmission. The network device may further transmit the downlink shared channel transmission in accordance with the resource allocation information in the downlink control channel transmission.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example of a two-symbol CORESET with CCEs and REGs.

FIG. 3 is a diagram illustrating examples of non-interleaving and interleaving REG-to-CCE mappings.

FIG. 4 is a diagram illustrating examples of PDCCH candidates with aggregation levels (ALs) 4, 8, and 16 in a CORESET of 16 CCEs (e.g., for a non-interleaved configuration).

FIG. 5 is a diagram illustrating an example of EREG-to-RE mapping for a cyclic prefix length for a frequency-division duplex (FDD) system.

FIG. 6 is a diagram illustrating examples of symbols allocated to a demodulation reference signal (DMRS) for PUCCH formats 3 and 4 for a number of allocated symbols.

FIG. 7 is a diagram illustrating an example of generating PUCCH formats 3 and 4.

FIGS. 8A and 8B are diagrams illustrating examples of peak power added efficiency versus frequency for power amplifiers using silicon transistors (FIG. 8A) and GaN/GaAs transistors (FIG. 8B).

FIG. 9 is a diagram illustrating an example of saturated output power versus frequency.

FIG. 10 is a diagram illustrating examples of CORESETs with dedicated DMRS symbols.

FIG. 11 is a diagram illustrating an example of physical layer processing for a DFT pre-coded PDCCH with dedicated DMRS symbols.

FIGS. 12A-12C are diagrams illustrating examples of DMRS mappings for a six-symbol CORESET.

FIGS. 13A-13C are diagrams illustrating examples of configurations with different CCEs sizes and allocation patterns.

FIGS. 14A and 14B are diagrams illustrating examples of DFT precoding with one or more DFT precoders.

FIG. 15 includes diagrams illustrating examples of CCE multiplexing based on a number of PRBs allocated in an OFDM symbol (e.g., with an example CCE size).

FIG. 16 includes diagrams illustrating examples of CCE multiplexing in time and/or frequency domains.

FIGS. 17A and 17B are diagrams illustrating examples of CCE multiplexing in the code domain.

FIGS. 18A and 18B are diagrams illustrating examples of RG/RGs-to-CCE mappings based on a DFT size and a CCE multiplexing pattern.

FIGS. 19A-19D are diagrams illustrating examples of RG interleaving in time/frequency domains.

FIGS. 20A-20C are diagrams illustrating examples of a two-symbol CORESET with contiguous and non-contiguous PRB allocations.

FIGS. 21A-21C are diagrams illustrating examples of two-symbol and four-symbol CORESETs with a non-contiguous PRB allocation and different types of RG interleaving.

FIGS. 22A and 22B are diagrams illustrating examples of RG mappings with a time domain interleaving configuration.

FIGS. 23A and 23B are diagrams illustrating examples of RG mappings with a frequency domain interleaving configuration.

FIGS. 24A and 24B are diagrams illustrating examples of RG mappings with time and frequency domain interleaving configurations.

FIG. 25 is a flow diagram illustrating example actions by a WTRU that may be performed to accomplish one or more of the tasks described herein.

FIG. 26 is a flow diagram illustrating example actions by a WTRU that may be performed to accomplish one or more of the tasks described herein.

FIG. 27 is a flow diagram illustrating example actions by a WTRU that may be performed to accomplish one or more of the tasks described herein.

FIG. 28 is a flow diagram illustrating example actions by a WTRU that may be performed to accomplish one or more of the tasks described herein.

FIG. 29 is a flow diagram illustrating example actions by a WTRU that may be performed to accomplish one or more of the tasks described herein.

FIG. 30 is a flow diagram illustrating example actions by a WTRU that may be performed to accomplish one or more of the tasks described herein.

### EXAMPLE NETWORKS FOR IMPLEMENTATION OF THE EMBODIMENTS

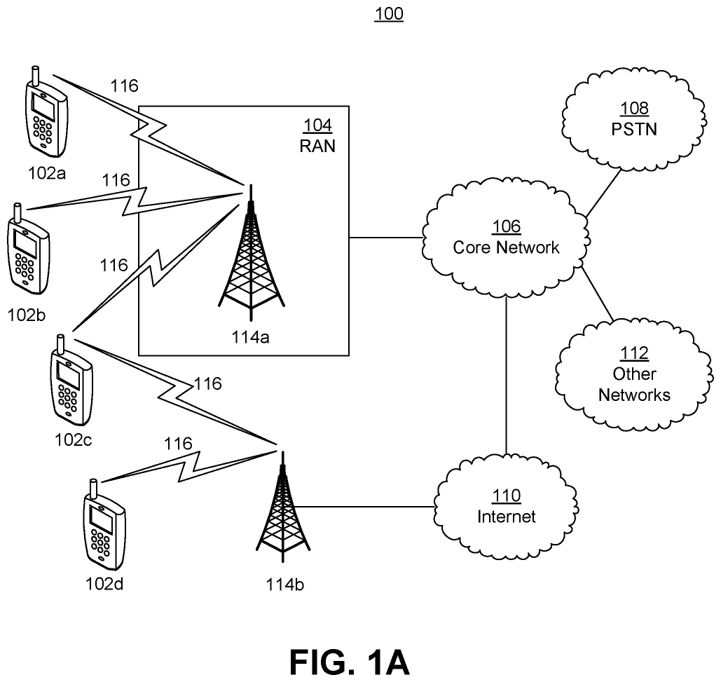

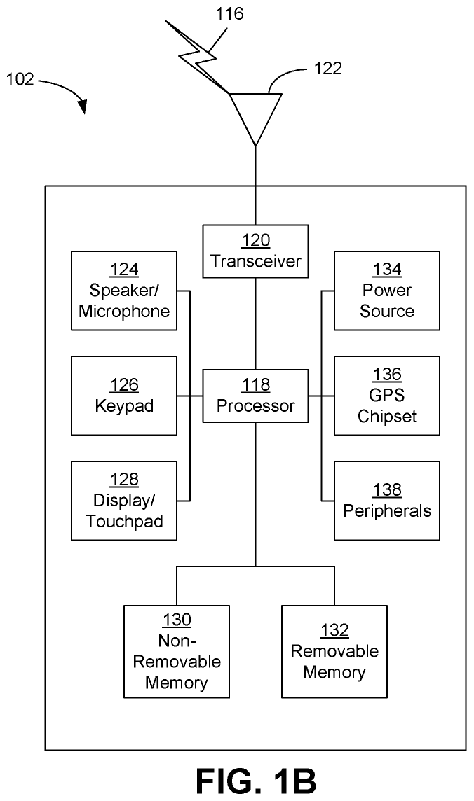

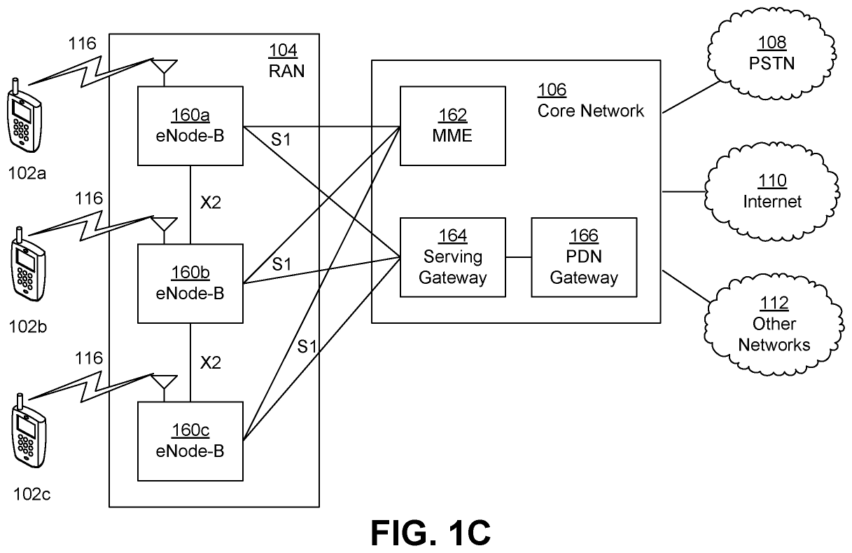

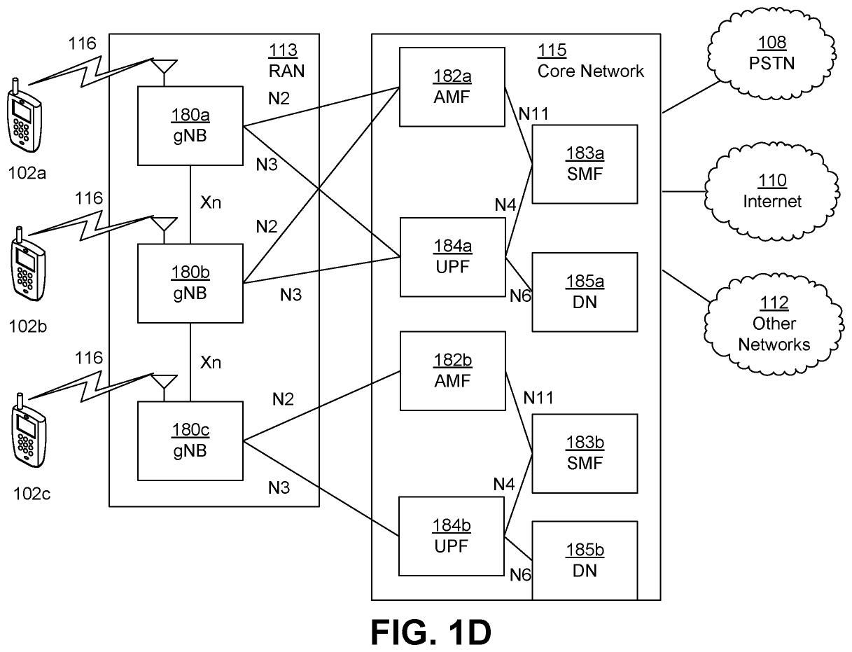

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Downlink control information (DCI) for a WTRU may be carried over a physical downlink control channel (PDCCH), which may correspond to physical layer signaling from layer 1. Multiple DCIs with different formats may be configured for different purposes, for example, as shown in Table 1.

TABLE 1
Examples of DCI Formats (e.g., supported in NR)

| DCI Formats | Application |
|---|---|
| DCI 00 | PUSCH resources for uplink |
| DCI 01 | PUSCH resources for uplink |
| DCI 02 | PUSCH resources for uplink (compact, for URLLC) |
| DCI 10 | PDSCH resources for downlink |
| DCI 11 | PDSCH resources for downlink |
| DCI 12 | PDSCH resources for downlink (compact, for URLLC) |
| DCI 20 | Group Signaling - Slot format, COT duration, available |
| | RB set, search space set group switch, etc. |
| DCI 21 | Group Signaling - Pre-emption Indication |
| DCI 22 | Group Signaling - TPC command for UL |
| DCI 23 | Group Signaling - TPC command for SRS transmission |
| DCI 24 | Group Signaling- UL transmission cancellation indication |
| DCI 25 | IAB-MT - Soft Resources Indication |
| DCI 26 | Group Signaling - Wakeup indication |
| DCI 27 | Group Signaling - Paging early Ind and TRS availability |
| | Indication |
| DCI 30 | NR SL PSCCH and PSSCH resources Indication |
| DCI 31 | NR SL PSCCH and PSSCH resources Indication |
| DCI 40/41/42 | PDSCH Broadcast/Multicast |

A PDCCH transmission carrying DCI for a WTRU may be transmitted using resource elements that may belong to a control resource set (CORESET). Such a CORESET may define a time-frequency region within the WTRU's active bandwidth part (BWP), where the WTRU may expect to receive the PDCCH transmission (e.g., the DCI included therein). The WTRU may be configured with one or more CORESETs over the WTRU's active bandwidth part and each CORESET may include a set of contiguous or non-contiguous physical resource blocks (PRB). The PRBs may be configured using a granularity (e.g., a 6-PRB granularity) and the WTRU may attempt to receive and/or decode (e.g., blindly decode) a DCI based on the configured PRB granularity. In some examples, a CORESET may span one, two, or three (1, 2, or 3) contiguous OFDM symbols in the time domain. The duration of the CORESET may be configured for (e.g., provided to) the WTRU, for example, by higher layer signaling, such as via system information (SI) or a WTRU-specific RRC message (e.g., depending on whether the CORESET is a common CORESET or a WTRU-specific CORESET). The configurability of CORESETs may support (e.g., enable) efficient resource sharing between DL control and shared channels, which may allow for efficient Layer 1 signaling overhead management.

A PDCCH's resource elements may be defined in terms of a control channel element (CCE). For example, a CCE may include multiple (e.g., six) resource element groups (REGs), which may correspond to 72 resource elements. A PDCCH may use one or more CCEs. The number of CCEs allocated to a PDCCH may be defined based on an aggregation level. For example, a WTRU that experiences poor coverage may be allocated higher aggregation levels, for example, to allow for increased channel coding gains, higher quantities of redundancy, etc.

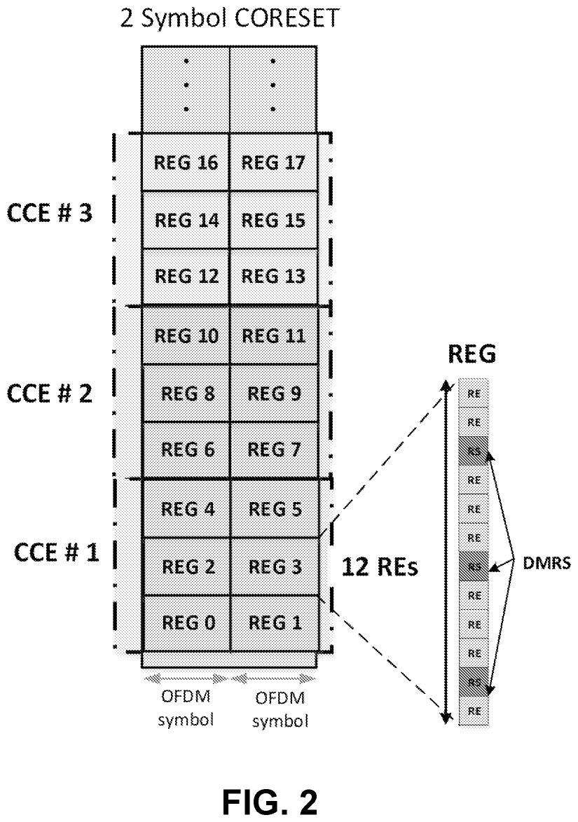

The resource elements belonging to a CORESET may be organized into REGs. In some examples, six (6) REGs may be included in a CCE. In some examples, three (3) REs within a (e.g., each) REG may be allocated for the transmission or reception of demodulation reference signals (DMRSes). FIG. 2 illustrates an example of a two-symbol CORESET format with multiple CCEs and REGs.

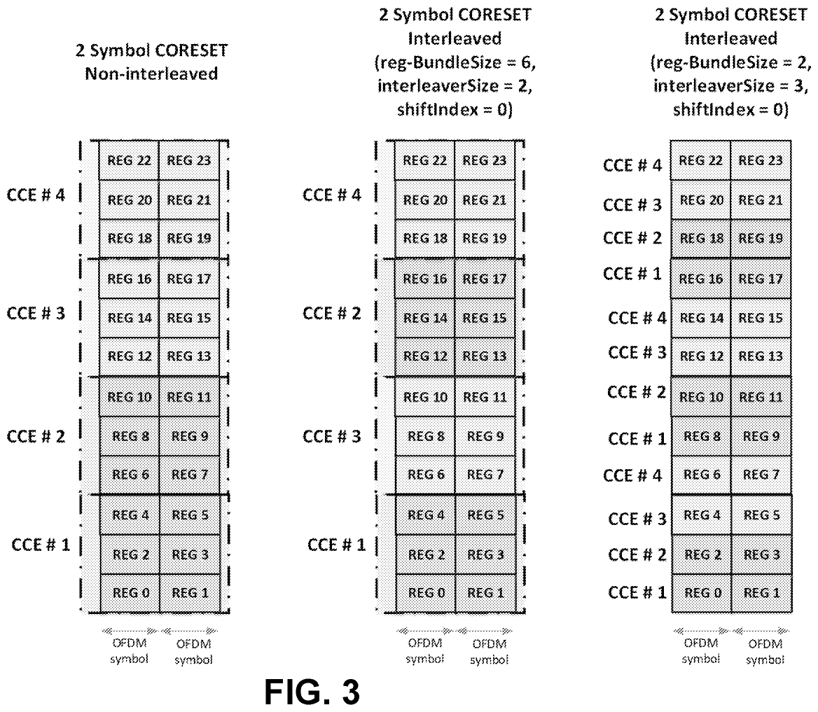

In some examples, the REGs within a CORESET may be numbered in an increasing order in a time-first manner (e.g., starting with 0 for the first OFDM symbol and the lowest-numbered resource block in the CORESET). A PDCCH may be mapped contiguously or non-contiguously in the frequency domain to the CORESET resources (e.g., by an interleaved mapping of REGs to a CCE). The PDCCH may have one or more continuous frequency segments according to a CORESET configuration. Non-interleaved (e.g., localized) and interleaved (e.g., distributed) CCE-to-REG mappings may be implemented. A (e.g., each) CORESET may be associated with a CCE-to-REG mapping, which may be interleaved or non-interleaved. The interleaved or non-interleaved CCE-to-REG mapping may be configured (e.g., by higher-layer signaling) such as the interleaving (if configured) may be in units of REG bundles. FIG. 3 illustrates examples of non-interleaving and interleaving mappings (e.g., REG-to-CCE mappings). In an example of a non-interleaving mapping, a CCE may be generated from a bundle of (e.g., six) consecutively numbered REGs. In an example of an interleaved mapping, frequency diversity may be achieved, for example, if the allocated REGs of a CCE are distributed across a CORESET. REG bundles (e.g., specified by a parameter such as reg-BundleSize) may be generated from multiple (e.g., 2, 3, or 6) REGs, for example, if an interleaved mapping is used. In some examples, REG bundle sizes of two or six may be used for one- or multi-symbol (e.g., two-symbol) CORESET formats. In some examples, REG bundle sizes of three or six may be used with a three-symbol CORESET format. A CCE may be generated, for example, by grouping REG bundles. An interleaver depth (e.g., specified by a parameter such as interleaverSize) may be configured to determine the number of sections into which a CORESET bandwidth may be divided when applying the interleaving. A shift index (e.g., specified by shiftIndex) information element may be used to apply a cyclic shift to the interleaving pattern. The cyclic shift may move the CCE pattern upwards (e.g., with wraparound from the top to the bottom).

PDCCH and/or DMRS transmissions may be performed using a (e.g., single) antenna port (e.g., port 2000). A WTRU may use the DMRS transmissions to estimate the composite impact of precoding and/or channel propagation. The WTRU may (e.g., depending on higher-layer configuration information for each CORESET) assume that the same precoding in the frequency domain may be used within a REG bundle (e.g., if precoderGranularity equals sameAsREG-bundle), or across multiple (e.g., all) REGs within a set of contiguous resource blocks (e.g., if precoderGranularity equals allContiguousRBs) of a CORESET.

A WTRU may receive DCI based on blind decoding, for example, if the WTRU is not aware of the exact position of a PDCCH candidate used by the network. The PDCCH candidates monitored by the WTRU may be configured using search space (SS) sets, wherein an (e.g., each) SS may be associated with a CORESET. In some examples, there may be multiple (e.g., two) types of search spaces. For example, there may be a common search space (CSS) set that may be used to send DCI commonly monitored by a group of WTRUs, and a WTRU-specific search space (USS) that may be used to send DCI monitored by a (e.g., specific) WTRU.

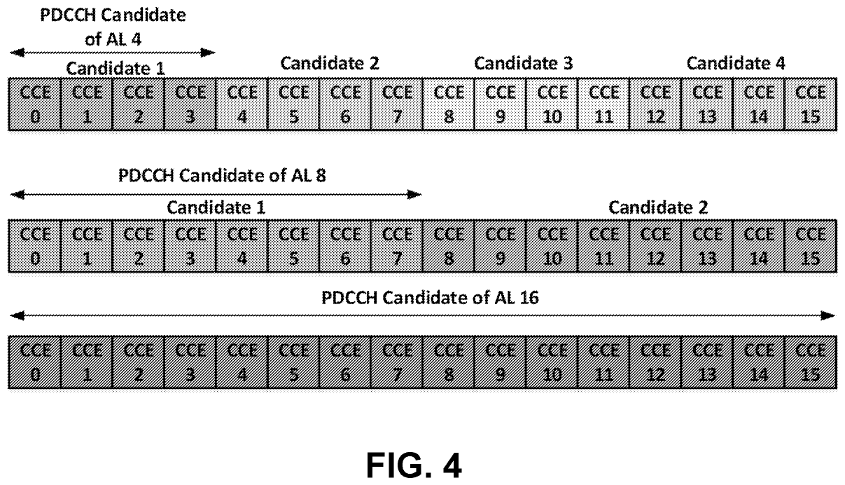

A search space configuration may indicate WTRU time indices (e.g., in terms of symbols/slots) to be monitored to receive a DCI. A (e.g., each) search space may be configured with one or more supported aggregation levels, and/or a number of candidate PDCCH transmissions for a (e.g., each) supported aggregation level. FIG. 4 illustrates examples of PDCCH candidates with aggregation levels (ALs) 4, 8, and 16 in a CORESET of 16 CCEs (e.g., for a non-interleaved configuration).

A WTRU may perform blind decoding of a DCI, for example, if the WTRU does not have (e.g., explicit) information about the DCI size, an AL associated with the DCI, and/or a PDCCH candidate associated with the DCI. The number of blind decodes (BDs) may be a function of the number of Als and/or the number of PDCCH candidates to be monitored for an (e.g., each) AL.

A search space set s may be associated with a CORESET p. The CCE indexes for aggregation level L that may correspond to PDCCH candidate

$${m}_{s , {n}_{CI}}^{( L )}$$

of the search space set in slot

$${n}_{s , f}^{μ}$$

for an active DL BWP of a serving cell that may be correspond to carrier indicator field value n_{CI} may be determined based on Equation (1) below:

$$L \times \{ ( {Y}_{p , {n}_{s , f}^{μ}} + ⌊ \frac{{m}_{s . {n}_{CI}}^{( L )} \times {N}_{CCE , p}}{L \times {M}_{s , max}^{( L )}} ⌋ + {n}_{CI} ) mod ⌋ {N}_{CCE , p} / L \} + i \qquad Equation ( 1 )$$

wherein

$${Y}_{p , {n}_{s , f}^{μ}}$$

may be 0 for a common search space (CSS), and, for a USS,

$${Y}_{p , {n}_{s , f}^{μ}} = ( {A}_{p} \times {Y}_{p , {n}_{s , f}^{μ} - 1} ) mod D ,$$

Y_{p,-1}=n_{RNTI}≠0, Aₚ=39827 for p mod 3=0, Aₚ=39829 for p mod 3=1, Aₚ=39839 for p mod 3=2, and D=65537. Further, i=0, . . . , L−1, and N_{CCE,p} may be the number of CCEs (e.g., numbered from 0 to N_{CCE,p}−1) in CORESET p. n_{CI} may represent a carrier indicator field value if a WTRU is configured with a carrier indicator field by CrossCarrierSchedulingConfig for the serving cell on which a PDCCH is monitored; otherwise, n_{CI} may be 0 (e.g., for any CSS).

$${m}_{s , {n}_{CI}}^{( L )} = 0 , … , {M}_{s , {n}_{C I}}^{( L )} - 1 , where {M}_{s , {n}_{C I}}^{( L )}$$

may be the number of PDCCH candidates that the WTRU may be configured to monitor for aggregation level L of a search space set s for a serving cell corresponding to n_{CI}.

$${M}_{s , max}^{( L )}$$

may be equal to

$${M}_{s , 0}^{( L )}$$

for a (e.g., any) CSS. For a USS,

$${M}_{s , max}^{( L )}$$

may be the maximum of

$${M}_{s , {n}_{C I}}^{( L )}$$

over (e.g., all) configured nCI values for a CCE aggregation level L of search space set s. A radio network temporary identifier (RNTI) value used for n_{RNTI} may be a cell RNTI (C-RNTI).

There may be limits on the maximum number of PDCCH candidates per slot and/or per serving cell and/or on the maximum CCE involving channel estimations per slot and per serving cell, for example, to limit the WTRU complexity and power consumption. The restrictions may be defined, for example, as a function of the subcarrier spacing.

A WTRU may be assigned or configured with different RNTIs. The RNTIs may be used to scramble the cyclic redundancy check (CRC) bits that may be attached to a DCI payload during physical layer processing. For example, a system information RNTI (SI-RNTI) may be used/configured for DCIs that may include information about system information (re-) acquisition, a paging RNTI (P-RNTI) may be used for DCIs that may include scheduling information for paging messages (e.g., for reception of a paging message), a C-RNTI may be used for DCIs that may include scheduling information for WTRU-specific DL and UL data transmissions, etc. The WTRU may use a configured RNTI to de-scramble the CRC bits of a DCI, for example, to determine whether the DCI is intended for the WTRU.

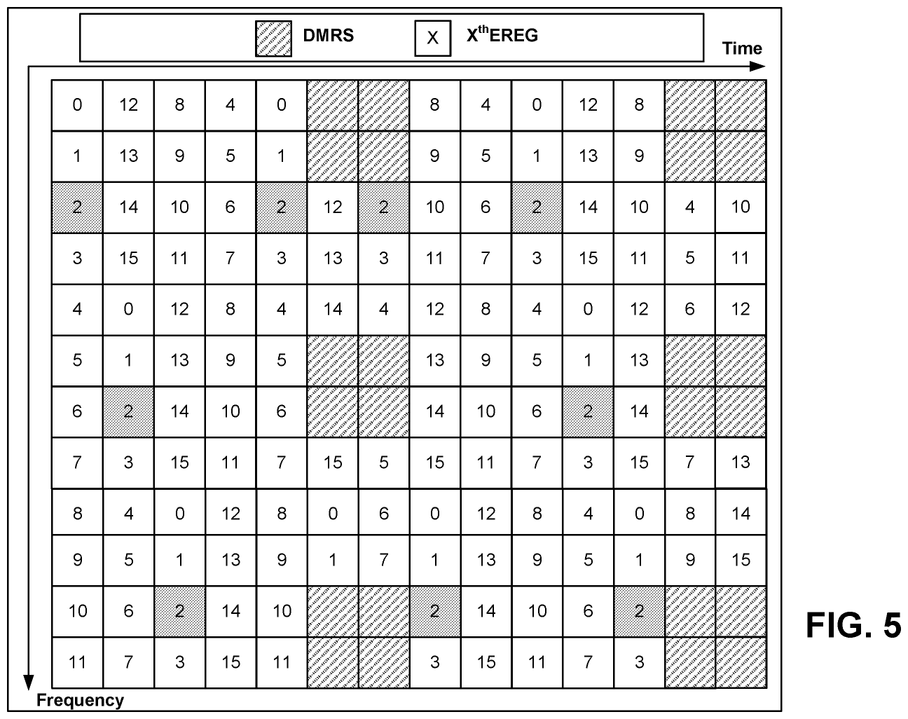

An enhanced physical downlink control channel (EPDCCH) may improve the capacity of a control channel through utilization of frequency-selective channel diversity, beamforming, and/or spatial reuse transmission techniques. The EPDCCH may be transmitted using one or more enhanced CCEs (ECCEs). An ECCE may include, for example, multiple (e.g., four or eight) enhanced REGs (EREGs). A PRB pair may carry multiple (e.g., 16) EREGs. An (e.g., each) EREG may include multiple (e.g., nine) REs. The multiple (e.g., 16) EREGs may be mapped (e.g., sequentially) to REs, for example, in a frequency followed by time manner within a PRB pair (e.g., by ignoring REs allocated to a DMRS). An EREG may be formed based on REs that may correspond to the index of the EREG, as illustrated by the example in FIG. 5. The mapping may allow the resources of the EREG to be spread (e.g., evenly) across the time and/or frequency resources of the PRB pair. The same or different sets of PRB pairs may be allocated to the EPDCCHs for different WTRUs, for example, so that the network may (e.g., flexibly) allocate the (e.g., total amount of) EPDCCH resources based on loading. The PRB pair locations in the frequency domain for the EPDCCH may be configured (e.g., specific to each WTRU), for example, via RRC signaling. The EPDCCH resources may occupy a subset of PDSCH resources. The network may exploit the same CSI in scheduling the EPDCCH. For example, the network may choose favorable sub-bands and/or precoders to achieve frequency-selective and beamforming gains.

FIG. 5 illustrates an example of an EREG-to-RE mapping for a cyclic prefix length of a frequency-division duplex (FDD) system.

EPDCCH multiplexing may be based on a form of frequency and/or spatial domain multiplexing. An EPDCCH may span the (e.g., total) time duration of a subframe. Frequency-selective channel diversity may be achieved in an EPDCCH, for example, through channel state aware selection of PRB pairs via localized transmissions and/or distributed transmissions of EREGs that may constitute the ECCEs of the EPDCCH.

Uplink transmissions may use CP-OFDM and/or DFT-s-OFDM waveforms, while downlink transmissions may use the CP-OFDM waveform, for example, to provide flexibility and/or achieve improved coverage in limited coverage scenarios. The DFT-s-OFDM waveform may be generated by enabling transform precoding (e.g., DFT based precoding) of a set of data and/or reference symbols

$$x ( n ) , n ∈ \{ 0 , 1 , … , {M}_{s c}^{p c} - 1 \}$$

for a (e.g., each) OFDM symbol, to generate a set of complex-valued symbols

$$y ( m ) , m ∈ \{ 0 , 1 , … , {M}_{s c}^{p c} - 1 \} .$$

The complex-valued symbols may be transmitted using the CP-OFDM waveform. Let

$${M}_{s c}^{p c}$$

represent the number of subcarriers allocated for the transmission of a set of data and/or reference symbols in a given OFDM symbol for a physical channel (pc), a transform precoding operation may be defined by Equation (2) below:

$$y ( m ) = \frac{1}{\sqrt{{M}_{s c}^{p c}}} {\sum }_{n = 0}^{{M}_{sc}^{p c} - 1} x ( n ) {e}^{- j \frac{2 π m n}{{M}_{s c}^{p c}}} \qquad Equation ( 2 )$$

where

$${M}_{sc}^{p c} = {M}_{R B}^{p c} {M}_{sc}^{R B}$$

may be defined in terms of a number of resource blocks (RBs)

$${M}_{R B}^{p c}$$

and/or number of sub-carriers per RB

$${M}_{s c}^{R B} .$$

The number of KBS allocated for an uplink transmission using the transform precoding operation may fulfill the following constraint:

$${M}_{R B}^{p c} = {2}^{{α}_{2}} \cdot {3}^{{α}_{3}} \cdot {5}^{{α}_{5}} ,$$

where a₂, a₃, a₅ may be a set of non-negative integers.

A precoded uplink control channel may be transformed. Uplink control information (UCI) may be carried over a physical uplink control channel (PUCCH) using CP-OFDM and/or DFT-s-OFDM waveforms (e.g., based on a UCI format). For example, UCI formats 0 and/or 1 may be carried over a PUCCH using the CP-OFDM waveform (e.g., UCI formats 0 and/or 1 may have a payload size of 1 or 2 bits). UCI formats 3 and/or 4 may be carried over a PUCCH using the DFT-s-OFDM waveform (e.g., UCI formats 3 and/or 4 may have a payload size of more than 2 bits). UCI format 2 may be carried using the CP-OFDM waveform (e.g., UCI format 2 may have a payload size of more than 2 bits).

UCI types reported in a PUCCH may include HARQ-ACK information, a scheduling request (SR), and/or channel state information (CSI). A WTRU may transmit one or multiple (e.g., two) PUCCHs on a serving cell in different symbols within a slot. The WTRU may have a dedicated PUCCH resource configuration (e.g., provided by PUCCH-ResourceSet in PUCCH-Config) or a common PUCCH resource configuration (e.g., provided through an index to a table of pre-configured resource sets by pucch-ResourceCommon). PUCCH formats 3 and 4 may be transmitted over one or more PUCCH resources provided to the WTRU (e.g., by a higher layer via a dedicated PUCCH resource configuration). The PUCCH resources may include one or more of the following: a PUCCH resource index (e.g., provided by pucch-ResourceId), an index of a (e.g., the first) PRB prior to frequency hopping or, for no frequency hopping, a startingPRB (e.g., if the WTRU is not provided with useInterlacePUCCH-PUSCH in BWP-UplinkDedicated), an index of a (e.g., the first) PRB after frequency hopping by secondHopPRB (e.g., if the WTRU is not provided with useInterlacePUCCH-PUSCH in BWP-UplinkDedicated), an indication of intra-slot frequency hopping by intraSlotFrequencyHopping (e.g., if the WTRU is not provided with useInterlacePUCCH-PUSCH in BWP-UplinkDedicated), an index of a first interlace by interlace0 (e.g., if the WTRU is provided with useInterlacePUCCH-PUSCH in BWP-UplinkDedicated), an index of a second interlace by interlace1 (e.g., if provided and/or if the WTRU is provided with useInterlacePUCCH-PUSCH in BWP-UplinkDedicated), an index of an RB set by rb-SetIndex (e.g., if the WTRU is provided with useInterlacePUCCH-PUSCH in BWP-UplinkDedicated), and/or a configuration for a PUCCH format.

In some examples (e.g., for PUCCH format 3), the PUCCH resources may include a number of PRBs provided by nrofPRBs, a number of symbols for a PUCCH transmission provided by nrofSymbols, and/or a first symbol for the PUCCH transmission provided by startingSymbolIndex. The PUCCH resources may include an index of a second interlace (e.g., indicated by interlace1) if a WTRU is provided with useInterlacePUCCH-PUSCH in BWP-UplinkDedicated and if PUCCH-ResourceExt is provided. If the WTRU is not provided with interface1, The PUCCH resources may include an orthogonal cover code length (e.g., indicated by occ-Length) and/or an orthogonal cover code index (e.g., indicated by occ-Index).

In some examples (e.g., for PUCCH format 4), the PUCCH resources may include a number of symbols for a PUCCH transmission (e.g., provided by nrofSymbols), an orthogonal cover code length (e.g., provided by occ-Length), an orthogonal cover code index (e.g., provided by occ-Index), and/or a (e.g., first) symbol for the PUCCH transmission (e.g., provided by startingSymbolIndex). In some examples (e.g., for PUCCH transmission in FR2-2), the PUCCH resources may include a number or PRBs

$${M}_{R B}^{PUCCH , 4}$$

(e.g., provided by nrofPRBs). In some examples (e.g., for PUCCH transmission not in FR2-2),

$${M}_{R B}^{PUCCH , 4}$$

may be equal to 1.

In some examples, PUCCH format 3 and/or format 4 (e.g., based on a PUCCH resource configuration) may have a long transmission duration that may span multiple (e.g., 4 to 14) OFDM symbols. PUCCH format 3 may support the transmission of the maximum PUCCH payload size (e.g., 1706 bits). PUCCH format 3 may be configured, for example, by 1 to 16 RBs or 20 RBs, e.g., if a WTRU is provided by useinterlacePUCCH-PUSCH and/or if multiple (e.g., two) interlaces are configured. Otherwise, PUCCH format 4 may be configured with multiple RBs in FR2-2. PUCCH format 4 may be configured with a single RB. Block-wise spreading (e.g., using a spreading factor ∈{1, 2, 4}) may be determined by the higher layer parameter occ-Length. Block-wise spreading (e.g., using a spreading factor ∈{1, 2, 4}) may be applied for PUCCH format 3, for example, if interlaced mapping is configured and/or if (e.g., only if) a single interlace is configured. Block-wise spreading (e.g., using a spreading factor ∈{2, 4}) may be determined by the higher layer parameter occ-Length. Block-wise spreading (e.g., using a spreading factor ∈{2, 4}) may be applied for PUCCH format 4.

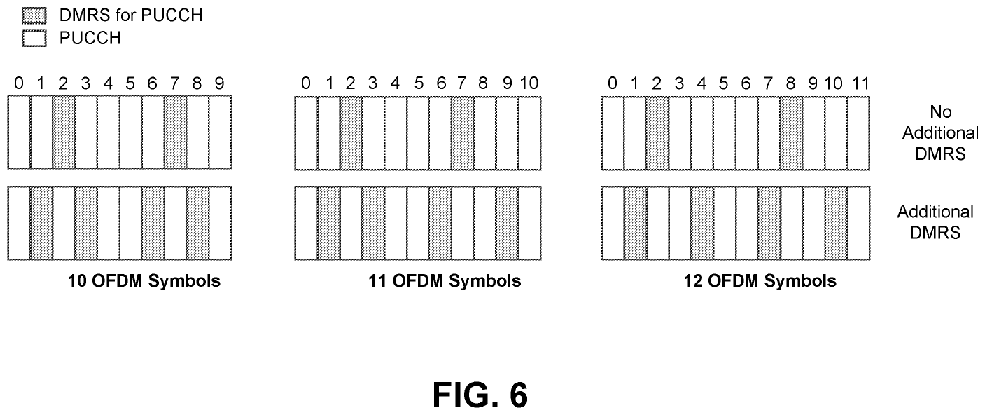

PUCCH format 3 and/or format 4 may carry UCI symbols and/or a demodulation reference signal (DMRS), for example, to assist in the demodulation of the UCI symbols. PUCCH format 3 and/or format 4 may be transmitted, for example, on antenna port p=2000. The DMRS may be allocated dedicated OFDM symbols and/or DMRS mapping/positions for PUCCH format 3 and 4, for examples, as shown in Table 2, for cases with or without intra-slot frequency hopping and/or an additional DM-RS. FIG. 6 illustrates an example allocation of resources for a PUCCH and a DMRS for the PUCCH for PUCCH formats 3 and 4 with a number of allocated OFDM symbols ∈{10, 11, 12}. PUCCH format 3 and/or format 4 may support repetitions of orders {2, 4, 8} across slots, for example, to provide additional improvement of coverage and reliability.

TABLE 2
Example of DM-RS positions for PUCCH formats 3 and 4.

| | DM-RS position/within PUCCH span | | | |
|---|---|---|---|---|
| PUCCH | No additional DM-RS | | Additional DM-RS | |
| length | No hopping | Hopping | No hopping | Hopping |
| 4 | 1 | 0, 2 | 1 | 0, 2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

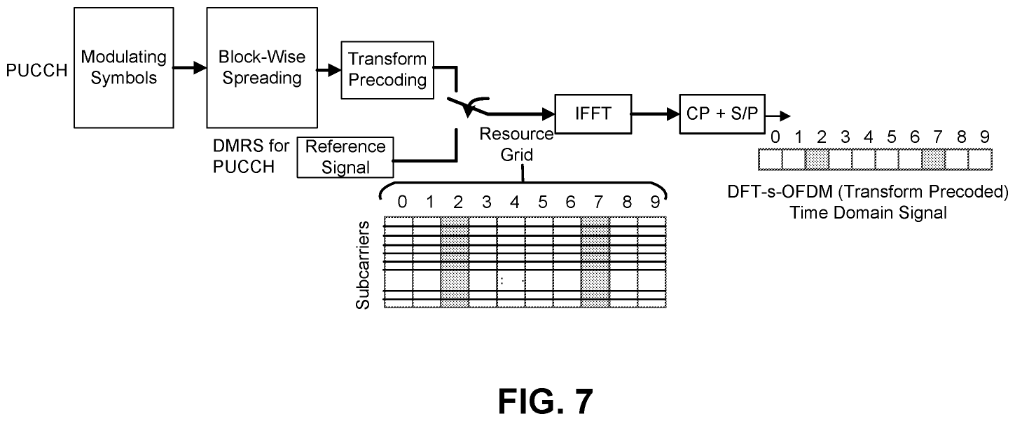

FIG. 7 illustrates an example of generating PUCCH formats 3 and 4.

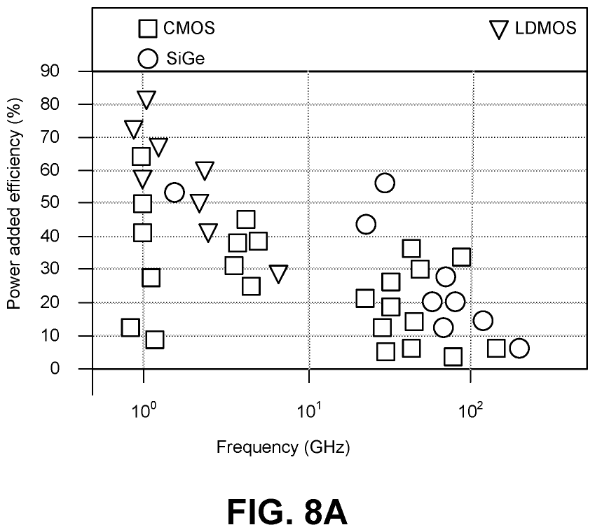

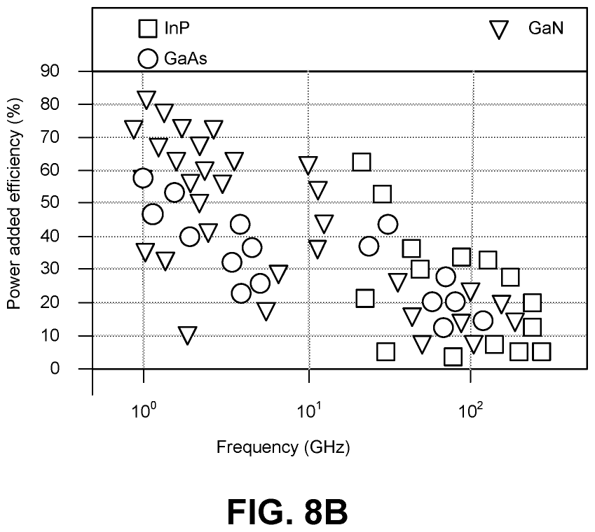

A power amplifier (PA) may be a power consuming unit at a transmitter. PA efficiency may be an important metric for system performance. FIGS. 8A and 8B illustrate examples of power added efficiency (PAE) versus operating frequency for PAs made using silicon transistors (e.g., SiGe) and semiconductor transistors (GaAs and GaN), respectively. Energy efficiency may be dependent on an operating frequency. There may be a downward trend in efficiency as a function of operating frequency (e.g., the higher the frequency, the lower the PA efficiency). The PAE may be defined, for example, in accordance with Equation (3) below:

$$PAE = \frac{{P}_{o u t} - {P}_{in}}{{P}_{d c}} \qquad Equation ( 3 )$$

where Pₒᵤₜ may represent the output power delivered by an amplifier and Pᵢₙ may represent an input power that may be handled by the amplifier. The maximum input power that may be handled by a PA may be determined by the PA's saturated output power. P_{dc} may represent the DC power supplied to the amplifier. PAE may be reduced to power efficiency (PE) in accordance with Equation (4) below, for example, if/when the PA output power is much higher than the input power (e.g., with very high PA gains):

$$PE = \frac{{P}_{o u t}}{{P}_{d c}} \qquad Equation ( 4 )$$

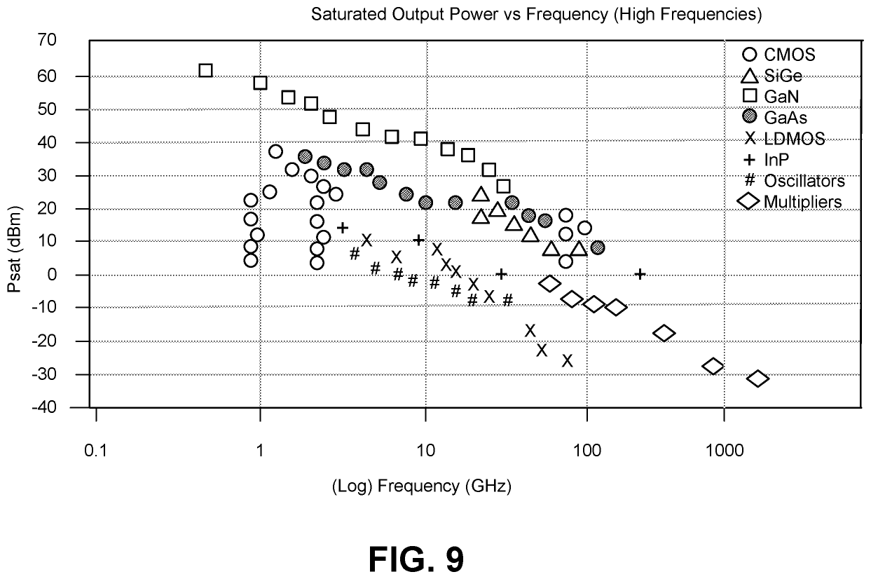

As shown by Equations (3) and (4), the PA may be driven at the maximum output power (e.g., saturated power Pₛₐₜ) to maximize the average PA efficiency, which may be dependent on the characteristic of the driving input signal (e.g., for signals of a substantially constant envelope). The PA operating point (e.g., the input signal's average power) may be backed off, or (e.g., for a target average output power) the PA may be selected to have a saturated power (Pₛₐₜ) that may be higher than the input signal's average power (e.g., by a value that is relative to the input signal's PAPR). This may be done, for example, for signals that do not exhibit constant envelope characteristics. FIG. 9 shows an example of a PA saturated power as a function of frequency for different technologies. As shown in FIG. 9, there may be an inverse relationship between Pₛₐₜ and the operating frequency (e.g., an increase in the operating frequency may result in a decrease in the PA's supported saturated power). Operating at higher frequency bands may result in a decrease in the PA's saturated power and/or a reduction in the PA's average output power, which may be further aggravated by the PAPR of the input signal.

A PAPR may be defined for discrete (e.g., OFDM) signals as the ratio of a maximum instantaneous (e.g., peak) power of a time-domain sequence s(n) to the average power of a time-domain sequence s(n), e.g., as shown in Equation (5):

$$PAPR = \frac{max \{ {\vert s ( n ) \vert}^{2} \}}{𝔼 \{ {\vert s ( n ) \vert}^{2} \}} \qquad Equation ( 5 )$$

wherein E{·} may denote the expectation or mean of the signal sequence. The PAPR of a signal waveform may be used as a metric, with which a smaller value may imply a more efficient operation of the power amplifier used to transmit the signal. Signals that may exhibit PAPR of 0 dB may be considered constant-envelope signals. The PAPR metric may be used for a high frequency band, where power amplifier efficiency and saturated power may be critical.

DFT-s-OFDM may be a single-carrier waveform and may be used for the uplink of a wireless communication system. The DFT-s-OFDM waveform may be characterized (e.g., due to its single-carrier nature) by a reduced peak-to-average power ratio (PAPR) compared to a multicarrier waveform such as the CP-OFDM waveform that may be used for the downlink of the wireless communication system. DFT-s-OFDM and/or CP-OFDM waveforms may possess the properties of simple frequency-domain equalization and/or simple inter-symbol interference (ISI) mitigation. A DFT-s-OFDM waveform for the downlink at high frequencies may address the challenges associated with coverage and/or energy/power efficiency. Design complexities and/or costs associated with base stations and WTRUs may be comparable at the high frequencies, where the coverage of a base station may be limited and the density of base station deployment may be high.

A power amplifier (PA) may be a power consuming unit at a transmitter. PA efficiency (e.g., power added efficiency (PAE) or power efficiency (PE) and/or PA saturated power (Pₛₐₜ) may depend on an operating frequency of the transmitter. There may be an inverse relationship between the PAE/PE/Pₛₐₜ and the operating frequency. For example, operating at a higher frequency band (e.g., at carrier frequencies above 100 GHz and towards the THz regime) may lead to lower PA efficiency and/or lower saturated power at the output of the PA. The power efficiency may be further aggravated by an input signal that may exhibit non-constant envelope characteristics (e.g., the input signal may have a high peak to average power ratio (PAPR)), for example, if the PA backs off from operating at a point with the highest efficiency and a maximum output power (e.g., at a PA saturated power).

As described herein, a DFT-s-OFDM waveform may be used for uplink communications. The DFT-s-OFDM waveform may be a single-carrier waveform and may be characterized by a reduced PAPR (e.g., compared to a CP-OFDM waveform) while still maintaining the properties of simple frequency-domain equalization and/or simple inter-symbol interference (ISI) mitigation. The DFT-s-OFDM waveform may also be used for downlink communications, for example, while operating in a frequency range that may be higher than a currently used frequency range to address challenges associated with coverage and/or energy/power efficiency.

A DFT-s-OFDM waveform (e.g., including transform precoding) may exhibit single-carrier waveform characteristics (e.g., in the time domain) if sub-carriers are mapped to contiguous frequency positions. The mapping may limit the flexibility of the DFT-s-OFDM waveform with respective to multiplexing control and data information in the frequency domain. As an example way of overcoming such limitations, control and data channels may not be multiplexed in frequency and may be allocated in different DFT-s-OFDM symbols to preserve the single-carrier nature of the waveform. Such a technique may also be applied to one or more reference signals (RSs), such as, e.g., a DMRS, which may not allow multiplexing of data information in the same symbol.

A CP-OFDM based downlink control channel may be used. The CP-OFDM based downlink control channel may provide a mechanism for reliable delivery of control information using a multitude of features, such as, e.g., an aggregation level, interleaving, time-frequency diversity exploitation, simultaneous transmissions of DMRS and control information over time and frequency resources at the resolution of a PRB and an OFDM symbol, etc. The shift to higher operating frequencies may result in performing data and control transmissions using a single carrier waveform.

A DFT-s-OFDM waveform-based downlink control channel may have single-carrier waveform characteristics (e.g., in terms of PA efficiency) and/or the flexibility provided by a CP-OFDM based-downlink control channel (e.g., in terms of frequency diversity, coverage, blocking probability, precoding, etc.). The DFT-s-OFDM waveform-based downlink control channel may be used to achieve key performance indicators (KPIs) associated with spectrum efficiency, network energy efficiency, and/or device power consumption.

A DFT pre-coded DL control channel, a DFT-s-OFDM based DL control channel, a DFT-s-OFDM waveform based DL control channel, and a DFT spread DL control channel may be used interchangeably herein. DFT precoding and transform precoding may be used interchangeably herein. DFT, a DFT module, and a DFT precoder may be used interchangeably herein. A gNB, an eNB, a network, and a base station may be used interchangeably herein. A PRB and a RB may be used interchangeably herein. A modulated symbol and a modulated data symbol may be used interchangeably herein. A symbol and an OFDM symbol may be used interchangeably herein.

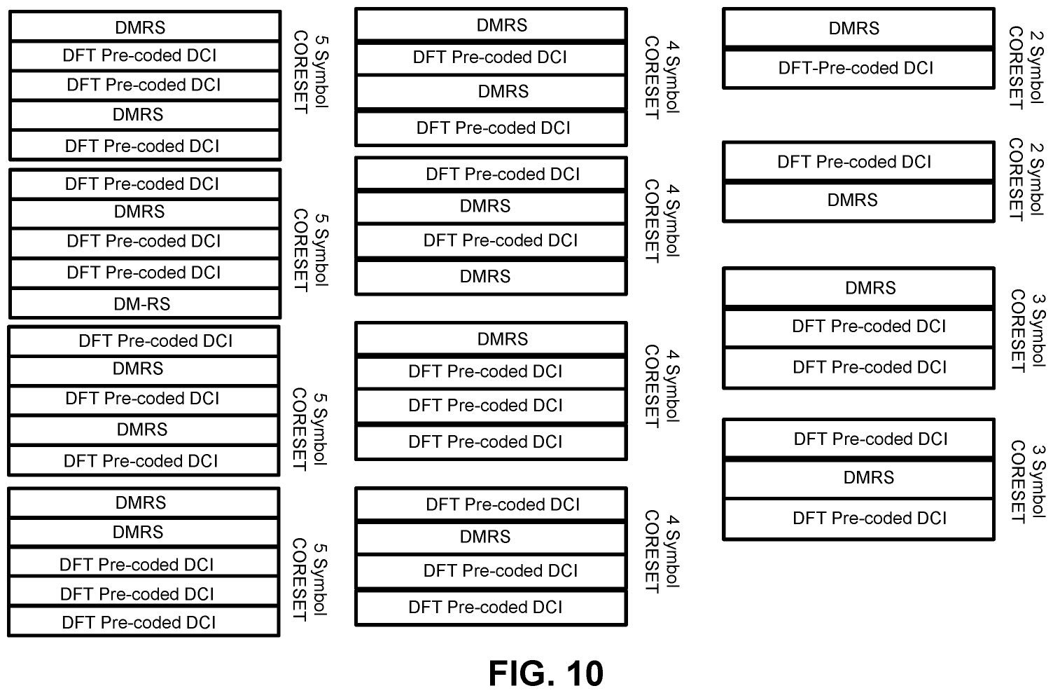

A DFT pre-coded physical DL control channel may be implemented and used in a wireless communication system. DMRS multiplexing may be implemented and used in the wireless communication system. The single carrier nature of DFT-s-OFDM signals (e.g., with reduced PAPR characteristics) may be maintained, for example, by avoiding or minimizing frequency-domain multiplexing of multiple signals. In an example of a DFT pre-coded DL control channel, DMRSes may be transmitted using resource elements associated with dedicated OFDM symbols. For example, REs used for a DMRS associated with a PDCCH transmission may include different OFDM symbols than those used to carry downlink control information (DCI) of the PDCCH transmission. In some examples, a multi-symbol (e.g., more than one OFDM symbol) CORESET format may include one or more symbols dedicated for DMRS transmissions. Different types of DMRS mappings may be configured for a CORESET. The locations of the OFDM symbols for DMRS transmissions may vary from one instance to another (e.g., even if the same number of OFDM symbols are allocated for PDCCH and DMRS transmissions). In some examples, one or more DMRS symbols may be allocated before symbols that may carry control data (e.g., front-loaded DMRS symbols), for example, to facilitate an early channel estimation. FIG. 10 illustrates examples of DMRS mappings with associated DFT pre-coded DCI on different OFDM symbols (e.g., CORESETs with dedicated DMRS symbols). The example mappings and/or patterns shown in FIG. 10 may be repeated one or more times over a (e.g., consecutive) duration of one or more OFDM symbols, slots, or subframes (e.g., for common search spaces). Each of the example patterns and/or mappings may be associated with a respective set of transmission beams or directions (e.g., the set of beams or beams may include one or more beams or directions). The example patterns and/or mappings may be separated by one or more OFDM symbols, for example, to allow time for beam switching. The same technique may also be applicable to overlapping dedicated search spaces for one or more WTRUs.

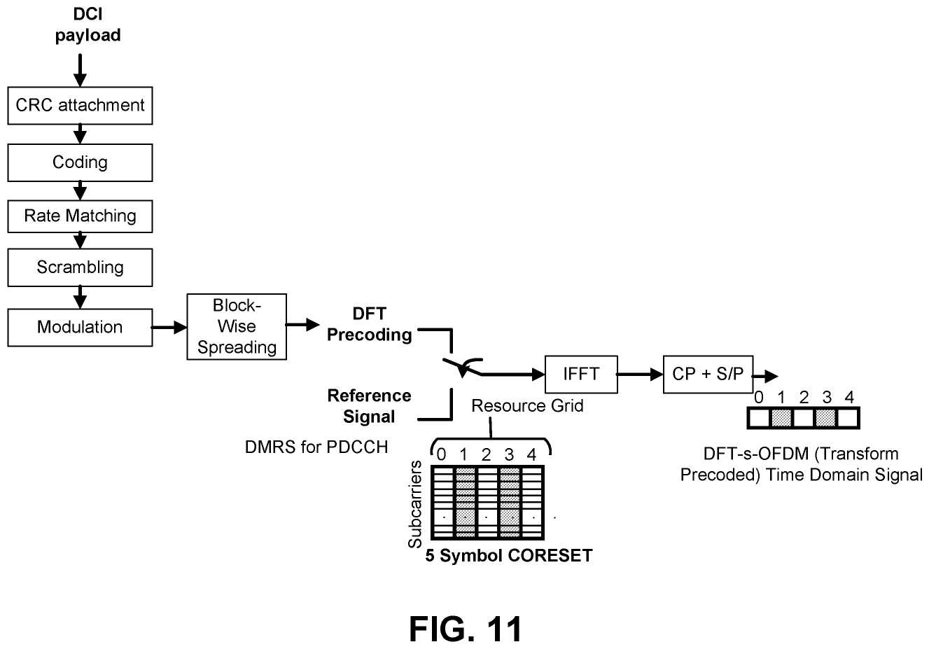

FIG. 11 illustrates an example of an architecture for generating a DFT pre-coded PDCCH with dedicated DMRS symbols (e.g., a 5-symbol CORESET with two DFT-s-OFDM symbols dedicated to DMRS). As shown in FIG. 11, a WTRU may alternate between PDCCH and DMRS transmissions over consecutive DFT-s-OFDM symbols (e.g., based on a CORESET configuration).

A WTRU may be configured with a DMRS configuration that may include one or more of the following parameters (e.g., for a CORESET configuration): time-domain allocation parameters, which may be used to derive the locations of DMRS OFDM symbols within a CORESET, frequency-domain allocation parameters, which may be used to derive the locations of DMRS REs in the frequency domain, DMRS sequence design parameters, which may include one or more of a sequence type, an initializing seed, a cyclic shift, a base sequence number, etc., and/or other parameters such as a modulation type, a spreading factor and a corresponding orthogonal sequence index, a precoding configuration, a number of DFT modules per CORESET, etc.

With respect to the time-domain allocation parameters described herein, a CORESET may include one or more OFDM symbols that may be used to carry a DMRS. One or more allocation mappings may be configured, for example, based on the number of OFDM symbols and/or the respective locations of the DMRS symbols in the CORESET. The DMRS configuration for the CORESET may vary with the number of symbols allocated for the PDCCH. The DMRS configuration parameters may include, for example, indices of the symbols that may carry a DMRS. In examples, the symbol indices may be defined with respect to the starting symbol of a slot that may include the CORESET and/or the starting symbol of the CORESET within the slot. In examples, the index of a first symbol that may include the DMRS may be determined, and the locations of additional DMRS symbols with respect to the first symbol may be configured for the WTRU. The length of a DMRS (e.g., in terms of the number of consecutive symbols, such as two or three symbols, that may carry the DMRS) may be configured for the WTRU.

A WTRU may be configured with a DMRS configuration including frequency-domain allocation parameters, which may be used to derive the locations of DMRS REs that may include resources in the frequency domain and OFDM symbols that may carry a DMRS). One or more allocation mappings may be configured based on the number of REs/PRBs (e.g., density) and/or their locations in an allocated bandwidth (e.g., PRBs) of a CORESET. The configuration parameters may include, for example, RE indices and/or PRB indices in one or more OFDM symbols that may carry the DMRS. The same frequency domain mapping or different frequency domain mappings may be configured for different OFDM symbols within a CORESET. In some examples, multiple (e.g., all) REs of a PRB associated with the allocated bandwidth of the CORESET may be used for DMRS mapping. In some examples, a subset of REs of a PRB associated with the allocated bandwidth of the CORESET may be used for DMRS mapping. REs that may not be used for DMRSes may be used for other purposes (e.g., for data or control information). In some examples, indices of the REs that may be used to carry DMRSes may be indicated in configuration information received by the WTRU. Different configuration mappings may be configured with different sets of REs in a PRB allocated for DMRSes for a given CORESET configuration. For example, configuration type 1 may allocate six REs (e.g., every other RE) of a PRB to a CORESET, configuration type 2 may allocate four REs (e.g., RE 0, RE 1, RE 5, RE 9, or RE 0, RE 3, RE 6, RE 9) of a PRB to a CORESET, and configuration type 3 may allocate all REs of a PRB to a CORESET. Other configurations with different numbers of REs and locations may be configured. In some examples, a subset of PRBs within the bandwidth of a CORESET may be configured for DMRSes. PRB indices may be indicated in the configuration. A same frequency domain mapping pattern may be configured for multiple (e.g., all) symbols (e.g., in case multiple symbols are allocated for DMRSes). In some examples, different types of frequency domain mapping patterns may be configured for different symbols. The DMRS configuration may indicate a frequency domain mapping configuration applied to a DMRS symbol.

A WTRU may be configured with DMRS configuration information that may include DMRS sequence design parameters, such as, e.g., a sequence type, an initializing seed, a cyclic shift, a base sequence number, etc. One or more of the parameters may be (e.g., explicitly) signaled or (e.g., implicitly) determined, for example, based on one or more of an OFDM symbol number, a slot number, a number of allocated frequency resources, a configured spreading sequence for the PDCCH, etc. The WTRU may be configured with additional DMRS configuration parameters, such as, e.g., a modulation type, a spreading factor and a corresponding orthogonal sequence index, a precoding configuration, a number of DFT modules per CORESET, etc.

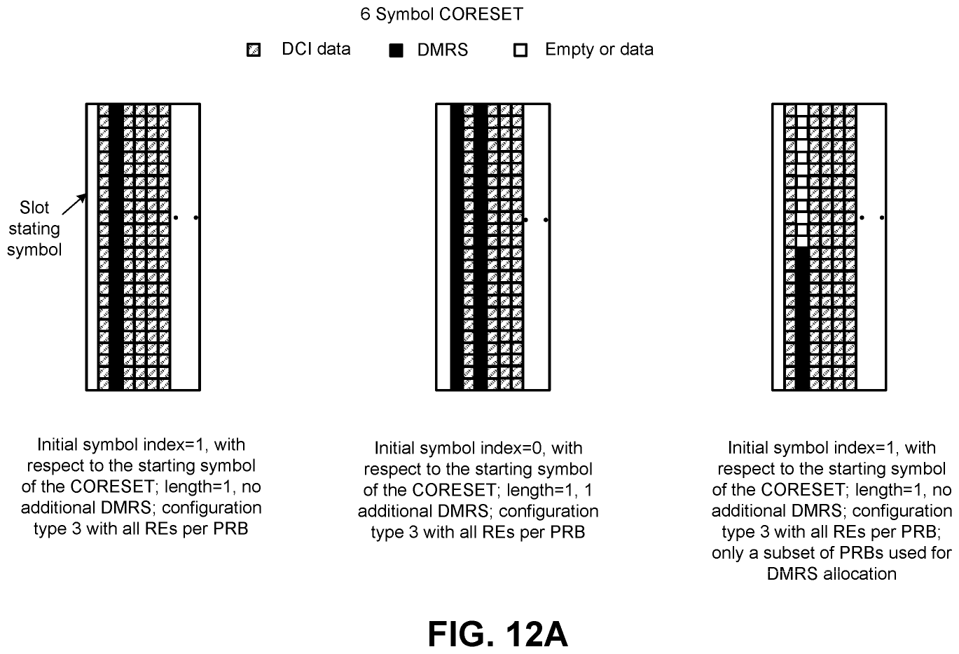

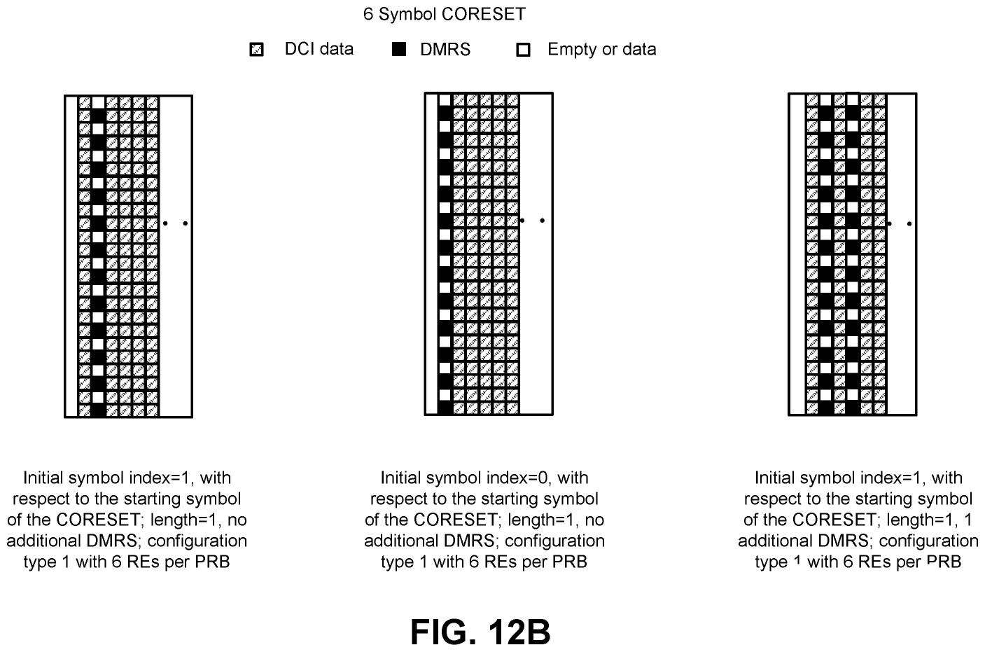

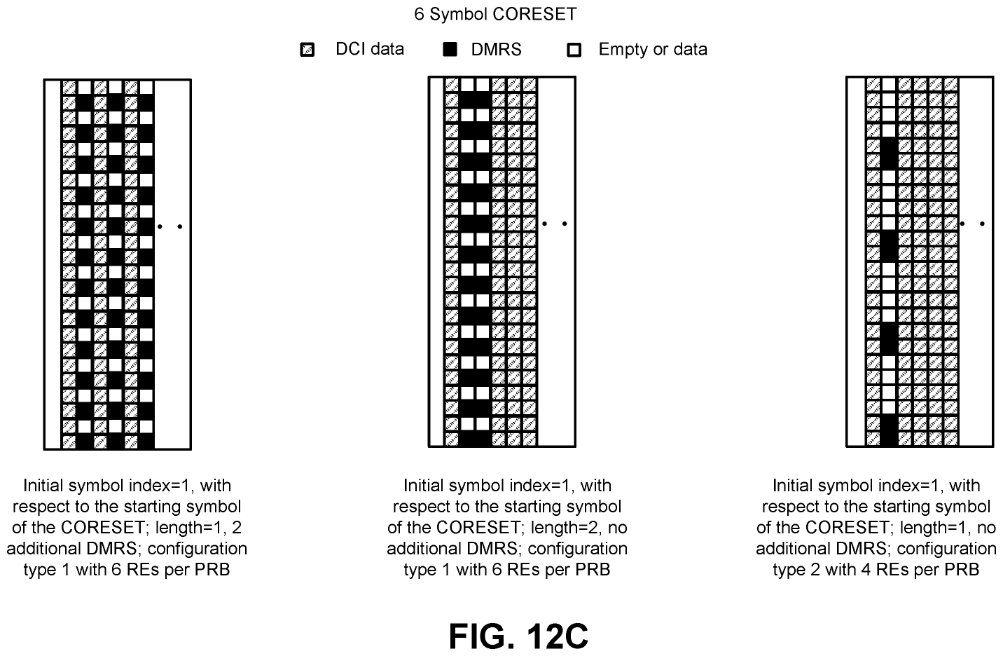

FIGS. 12A-12C show examples of DMRS mappings in a 6-symbol CORESET with different starting symbols, lengths (e.g., in terms of the number of consecutive DMRS symbols), the number of additional DMRS symbols, and frequency domain allocation configurations. Additional configurations may be derived by varying one or more of the these DMRS parameters. The DMRS configuration may be provided to a WTRU within a CORESET configuration (e.g., as part of ControlResourceSet and/or ControlResourceSetzero). The configuration information may be transmitted to the WTRU via higher layer signaling, such as, e.g., via an RRC message or system information (e.g., MIB, SIB 1, etc.).

A CCE size may be configured for and/or determined by a WTRU. A DMRS mapping may have an impact on dedicated OFDM symbols. The time-frequency resources of a CORESET may be organized into one or more CCEs that may be associated with one or multiple DCIs. A CCE (e.g., with an OFDM based DL control channel) may include multiple (e.g., six) REGs. A REG may include 12 REs and, as such, a CCE may include a total of 72 REs. For example, three REs in a REG may be allocated to DMRSes, leaving 54 REs in the CCE for DCI data. In an example of a DFT-s-OFDM based DL control channel with a DMRS allocated on dedicated OFDM symbols, one or more of the following may be applicable for the number of REs or PRBs allocated to a CCE. It should be noted here that, while the term CCE may be used in some examples provided herein, other terms may also be used to represent the same concept (e.g., a CCE as described herein may include more than DMRS resources in the frequency domain). Further, the number of modulated symbols carried by a DFT-s-OFDM based CCE (e.g., as described herein) may be different than the number of modulated symbols carried by a legacy, OFDM-based CCE. One or more of the following approaches may be considered and/or used with respect to a CCE. The number of REs and/or the corresponding number of modulated symbols per CCE may be maintained at 54 REs. The number of REs and/or the corresponding number of modulated symbols per CCE may be reduced, for example, to 48 REs (e.g., the equivalent of 4 RBs). The number of REs and/or the corresponding number of modulated symbols per CCE may be increased, for example, to 60 REs (e.g., the equivalent of 5 RBs).

The determination of the number of REs per CCE may be dependent on multiple factors, such as, e.g., a constraint on the number of modulated symbols conveyed via a PDCCH, the reliability of the PDCCH, and/or PDCCH multiplexing capabilities within a CORESET. In an example (e.g., when the number of REs per CCE is maintained at 54), a fractional number of RBs such as 4.5 RBs may be used for a (e.g., single) CCE. CCE multiplexing may be considered as part of the determination of the number of REs. For example, multiple CCEs (e.g., 2 aggregated or multiplexed CCEs) may occupy a number of frequency resources and OFDM symbols (e.g., 108 REs) that may be the equivalent of an integer number of RBs (e.g., 9 RBs), which may correspond to a non-integer or fractional (e.g., 9/2=4.5 RBs) number of RBs per CCE. The actual number of RBs may be dependent on the pattern of symbols allocated to a PDCCH and/or the number of multiplexed CCEs. For example, an allocation of three RBs and four OFDM symbols (e.g., including one OFDM symbol dedicated to a DMRS for the PDCCH) may be considered to multiplex two CCEs. In an example (e.g., when the number of REs per CCE is reduced to 48), a reduction in the number of REs may correspond to a lower PDCCH capacity (e.g., a reduction in the number of unique information bits that can be conveyed over the PDCCH) or a lower reliability (e.g., by considering a higher code rate or availability of fewer resources for rate matching). The impact on the PDCCH capacity and/or reliability may be dependent on the level of reduction in the allocated REs. The impact may be mitigated through other techniques, such as CCE aggregation. In an example (e.g., when the number of REs per CCE is increased to 60), increasing the number of REs may correspond to a higher PDCCH capacity (e.g., an increase in the number of unique information bits that can be conveyed over the PDCCH) or a higher reliability (e.g., by considering a lower code rate or availability of more resources for rate matching). Increasing the number of REs may come at the expense of higher resource utilization and/or lower PDCCH multiplexing capabilities, which may be acceptable if narrow beams at high frequencies may be expected to serve a limited number of WTRUs per beam at a point in time. The pattern of symbols allocated to the PDCCH may be repeated (e.g., in time) in support of beam switching (e.g., for a common search space). Sub-carrier spacing may be increased (e.g., at high frequencies), which may result in a smaller OFDM symbol duration and/or a limited impact on PDCCH decoding latency.

Symbols may be dedicated to a DMRS (e.g., for a PDCCH) based on the pattern of symbols allocated to the PDCCH and the DMRS. The allocation pattern may be categorized, for example, into a short allocation pattern or a long allocation pattern. The short allocation pattern may involve a small number of OFDM symbols (e.g., 2 OFDM symbols) allocated to the PDCCH and the DMRS. The short allocation pattern may correspond to a high DMRS overhead (e.g., 50% overhead for the 2 OFDM symbol case). The long allocation pattern may involve a relatively large number of OFDM symbols (e.g., 3 or more OFDM symbols) allocated to the PDCCH and the DMRS. The long allocation pattern may correspond to a low or high DMRS overhead, for example, based on the configuration of additional DMRS (e.g., ˜33% overhead for the 3 OFDM symbol case with a single OFDM symbol dedicated to DMRS).

In some examples, the same (e.g., fixed) value of CCE sizes and/or allocation patterns may be used across multiple (e.g., all) CORESETs for a WTRU. The WTRU may be pre-configured with the CCE size. In some examples, different values of CCE sizes and/or allocation patterns may be configured for different CORESETs. The WTRU may be configured with an associated CCE size and/or allocation pattern in each of the CORESET configurations given to the WTRU (e.g., via RRC or SI signaling).

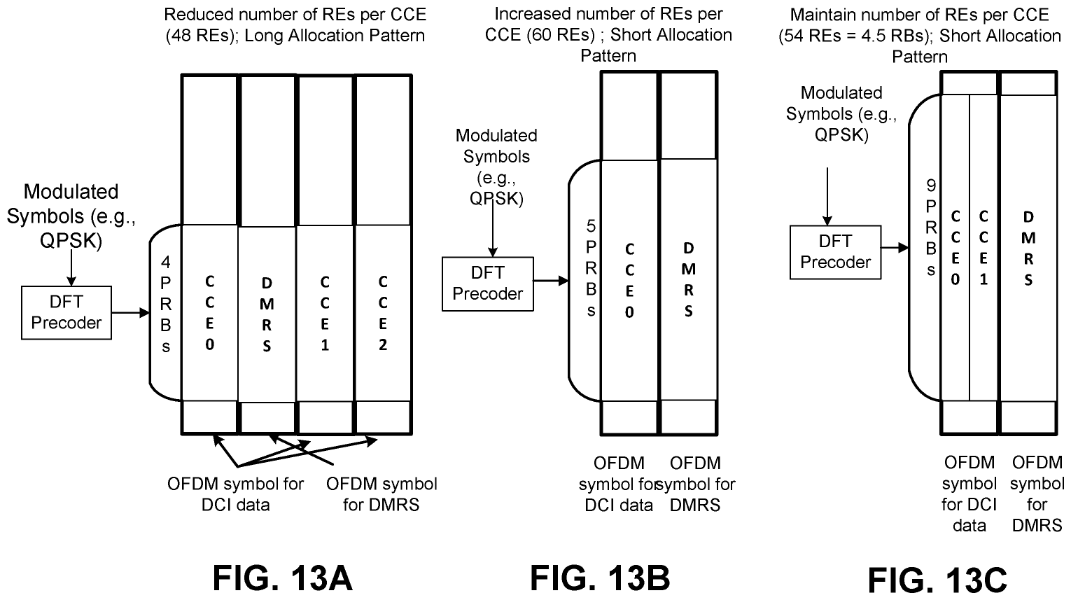

FIGS. 13A-13C show examples of different configurations in terms of CCE sizes and short/long allocation patterns. FIG. 13A shows an example of a long allocation pattern, where three OFDM symbols may be allocated for a CORESET with a symbol (e.g., the second symbol) dedicated to a DMRS. As shown in FIG. 13A, three CCEs may be multiplexed in the time domain (e.g., over different OFDM symbols), with each CCE having a size of four PRBs (e.g., 48 REs) corresponding the reduced number of REs per CCE described herein. FIG. 13B shows an example of a short allocation pattern with 2 OFDM symbols allocated for a CORESET, one symbol (e.g., the second symbol) dedicated to a DMRS, and a CCE size of five PRBs corresponding to the increased number of REs per CCE. FIG. 13C shows an example of a short allocation pattern with 2 OFDM symbols allocated for a CORESET with one symbol (e.g., the second symbol) dedicated to a DMRS, and two CCEs multiplexed in the same OFDM symbol (e.g., with each CCE having a size of 4.5 PRBs). This may be an example of maintaining the same number of REs per CCE.

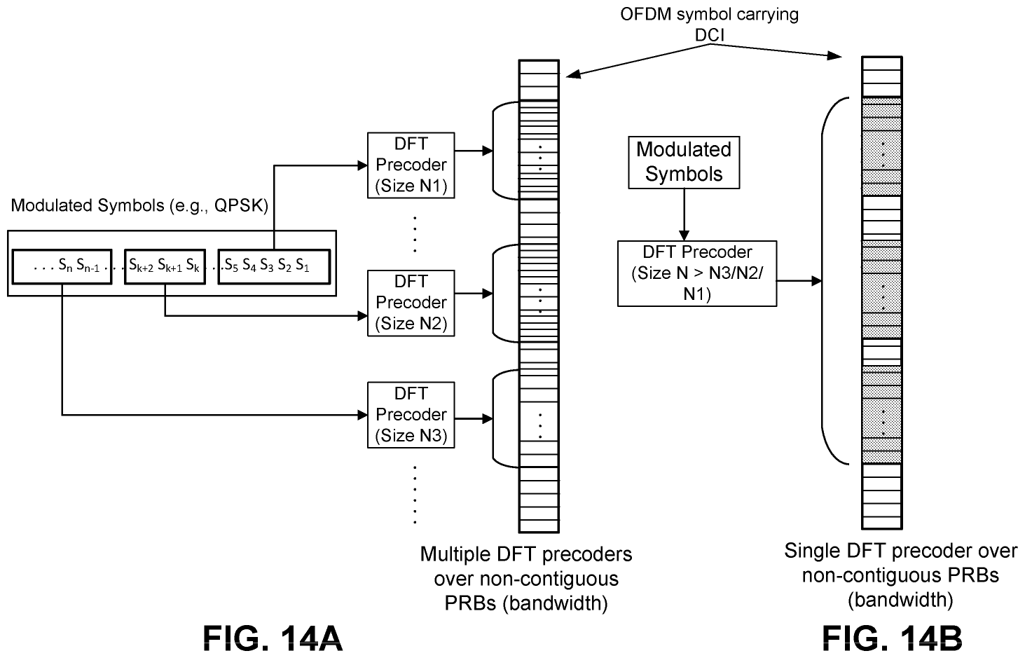

CCE allocation and multiplexing may be interrelated with DFT precoding. One or more DFTs may be used to apply transform precoding over a set of PDCCH modulated symbols for a CORESET. The one or more DFTs may be used to map DFT pre-coded output samples to a set of allocated REs (e.g., using contiguous or non-contiguous frequency resource allocation) over a set of OFDM symbols that may be associated with the CORESET and/or allocated to carry DCI. The sizes of the one or more DFTs (e.g., number of DFT samples, which may be equal to the number of REs over which the DFT pre-coded samples may be mapped) may be provided via one or more configuration parameters. For example, the one or more configuration parameters may indicate that the one or more DFTs may have the same size or different sizes. FIGS. 14A and 14B show examples of using multiple DFT precoders versus one DFT precoder over an OFDM symbol associated with a CORESET. For a given number of PRBs, a configuration (e.g., as shown in FIG. 14A) with a higher number of DFTs (e.g., with smaller DFT sizes) may have a higher PAPR compared to a configuration (e.g., as shown in FIG. 14B) with a lower number of DFTs (e.g., with larger DFT sizes). A configuration with separate DFT pre-coders within a OFDM symbol (e.g., as shown in FIG. 14A) may be referred to as a distributed DFT configuration. A configuration with a single DFT pre-coder within a OFDM symbol over non-contiguous PRBs (e.g., as shown in FIG. 14B) may be referred to as a clustered DFT configuration. The modulated symbols of one or more CCEs may belong to one or more PDCCHs addressed to one or more WTRUs.

CORESET configuration information may indicate a number of DFT precoders and/or their associated DFT sizes that may be used over an allocated bandwidth (e.g., one or more PRBs) and/or one or more OFDM symbols in a CORESET. In some examples, a same DFT size may be used for multiple (e.g., all) DFT pre-coders. In some examples, different DFT sizes may be used for different DFT pre-coders over an OFDM symbol. The CORESET configuration information may be provided (e.g., explicitly) as a sequence of integers indicating DFT sizes. The number of DFTs may be determined based on the length of the sequence. In some examples, the number of DFTs may be indicated (e.g., explicitly) via a first integer number, while a DFT size (e.g., which may be applicable to multiple DFTs) may be indicated via a second integer number. In some examples, the number of DFTs and/or their sizes may be implicitly indicated or deduced based on a sequence of integers that may indicate the number of multiplexed CCEs within subsets of frequency resources allocated in a CORESET and/or an OFDM symbol allocation pattern. The size of the subsets of frequency resources may be determined, for example, based on the number of multiplexed CCEs and/or the size of a (e.g., each) CCE associated with the indicated OFDM symbol allocation pattern. The order of the subsets of the frequency resources may be preconfigured for or signaled to a WTRU (e.g., as part of a CORESET configuration). For example, the WTRU may decide to use a first DFT pre-coder given in a list of DFT pre-coders over a first set of REs allocated for a CORESET (e.g., starting from the lowest index RE in the frequency domain), wherein the number of REs in the first set may be equal to the DFT size of the first DFT pre-coder. The WTRU may further decide to use a second DFT pre-coder given in the list of DFT pre-coders over a second set of REs, wherein the second set of RES may located (e.g., in the CORESET) subsequent to the first set of REs used by the first DFT pre-coder. The order of the REs may be determined based on the CORESET configuration information, and the number of REs in the second set may be equal to the DFT size of the second DFT pre-coder. The same configuration and/or operations described herein for the first and second DFT precoders may be applicable for additional (e.g., a third, a fourth, etc.) DFT precoders.

In some examples, a WTRU may be configured with a default or fixed DFT size that may be used for one or more DFT pre-coders over an OFDM symbol associated with a CORESET. The WTRU may determine the number of DFT pre-coders to be used over the OFDM symbol based on the number of PRBs (e.g., REs) allocated and/or the configured DFT size. The WTRU may (e.g., for each DFT pre-coder) determine the number of CCEs multiplexed in the time domain, for example, based on the configured DFT size and/or a CCE size.

Different schemes of CCE multiplexing (e.g., time, frequency, and/or code domain multiplexing) may be considered for a CORESET, for example, based on configuration information. For example, a WTRU may be configured to consider one or more (e.g., a combination of) time-based multiplexing (e.g., using a single DFT over an allocated CORESET bandwidth), frequency-based multiplexing (e.g., each CCE may be independently transform pre-coded), and/or code-based multiplexing (e.g., using a single DFT over an allocated CORESET bandwidth with an indication of code multiplexing and/or an orthogonal code length). The multiplexing scheme(s) may be configured explicitly and/or implicitly within a CORESET for one or more CCEs. For example, a multiplexing scheme may be determined based on one or more of a number of DFTs, a CCE size, a DFT size, a number of PRBs allocated within an OFDM symbol, an OFDM symbol allocation pattern (e.g., number of OFDM symbols allocated for DCI data), and/or the like. Multiplexed CCEs may be associated with one or more PDCCHs that may carry DCI intended for a single WTRU or multiple WTRUs (e.g., a WTRU group).

In some examples, a WTRU may be provided with a list of configurations regarding DFT modules and/or subsets of allocated frequency resources associated with the DFT modules. The size of such a list may indicate frequency domain multiplexing. For example, more than one DFT module configuration may be provided and each DFT module configuration may include a parameter indicating whether time or code multiplexing is used for the subset of frequency resources associated with the corresponding DFT module. In some examples, the WTRU may determine frequency multiplexing based on a received indication of the number of DFTs considered in a CORESET. The WTRU may be provided with a global multiplexing scheme for multiple (e.g., all) DFT modules within a CORESET (e.g., the global multiplexing scheme may be provided as a single CORESET configuration parameter). In some examples, the WTRU may blindly determine a time and/or code multiplexing scheme associated with a DFT module in a configured CORESET. The WTRU may determine the number of CCEs multiplexed in the time or code domain over an OFDM symbol based on one or more of a CCE size, a DFT size used for a DFT pre-coder, and/or an OFDM symbol allocation pattern.

A WTRU may be configured with an orthogonal cover code (OCC) length for code domain multiplexing. The OCC length may depend on the number of multiplexed CCEs. A (e.g., each) CCE may be spread by an OCC from a set of preconfigured codes based on the determined OCC length. The number of CCEs multiplexed (e.g., within the same time and frequency resources) may depend on the OCC length. The WTRU may be configured with a set of orthogonal cover codes, which the WTRU may use to extract the CCEs multiplexed in the code domain.

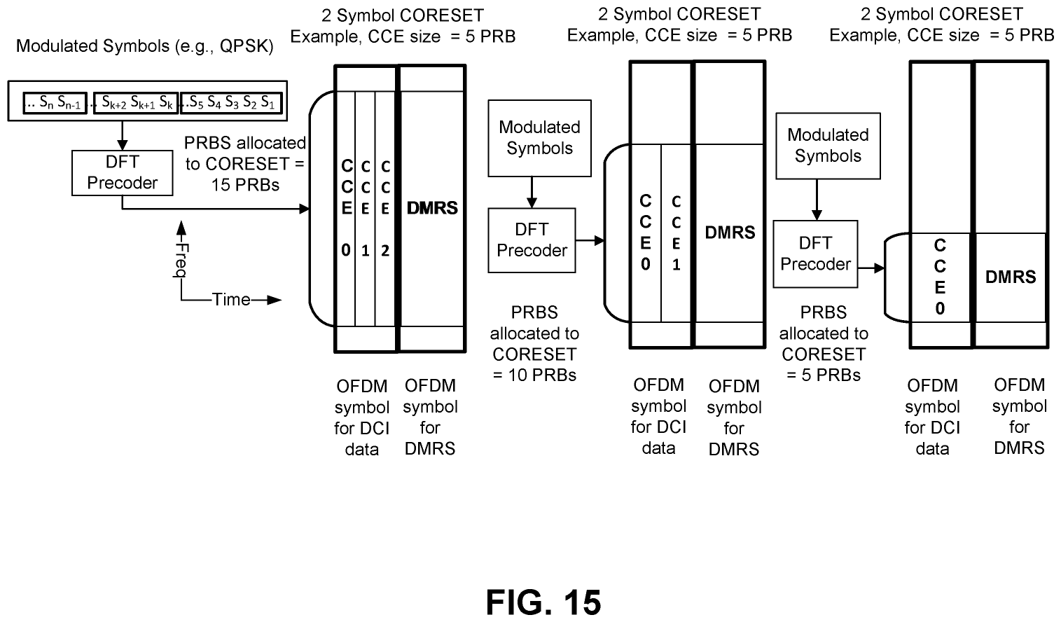

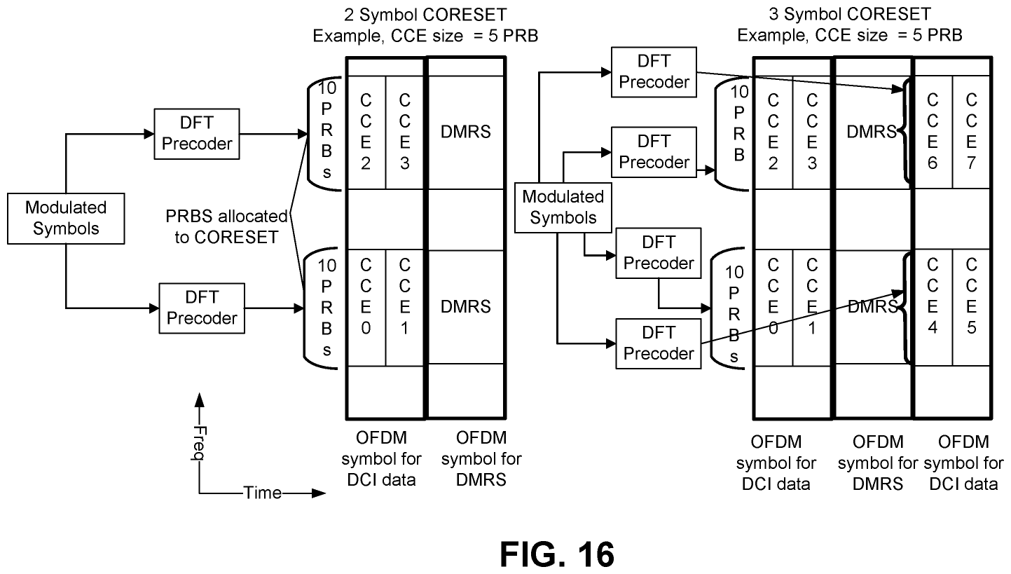

FIG. 15 shows examples of time domain CCE multiplexing in an OFDM symbol. As shown in FIG. 15, the number of CCEs (e.g., CCEs ∈{3, 2, 1}) may be determined based on the number of PRBs allocated for a CORESET (e.g., RBs ∈{15, 10, 5}), a CCE size (e.g., 5 RBs per CCE), and/or an OFDM symbol allocation pattern (e.g., two OFDM symbols are allocated with one OFDM symbol dedicated to a DMRS for PDCCH). FIG. 16 shows examples of combinations of time and frequency (e.g., using different DFT precoders) domain multiplexing based on a number of DFTs (e.g., 2), a CCE size (e.g., 5 RBs), a total number of RBs per CORESET (e.g., 10 RBs per CORESET), and/or an OFDM symbol allocation pattern (e.g., with 2 or 3 allocated OFDM symbols and one OFDM symbol dedicated to a DMRS for PDCCH).

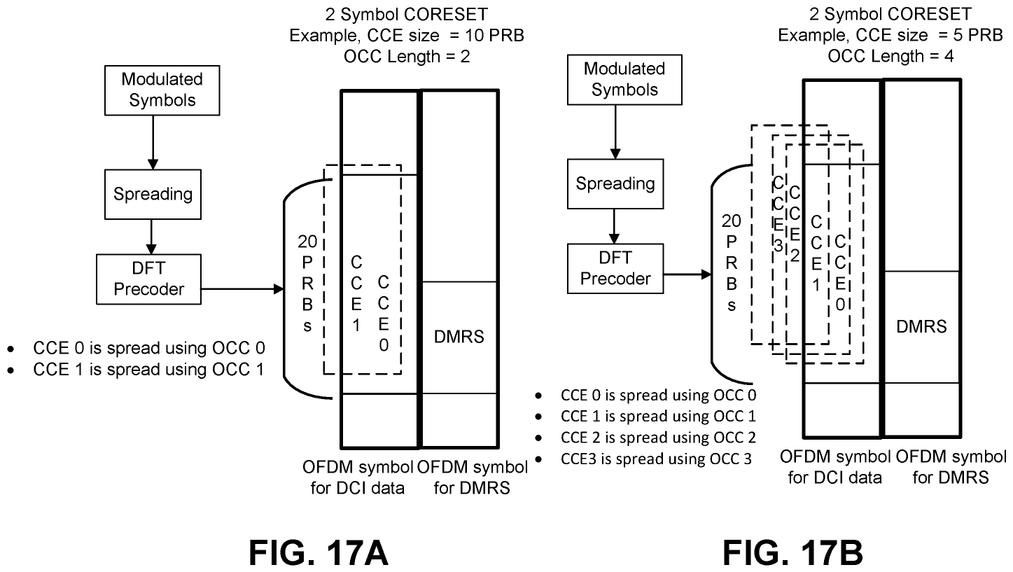

In examples of multi-symbol CORESETs (e.g., when multiple OFDM symbols are allocated to send DCI data within a CORESET), the same or different configurations with respect to the number of DFT pre-coders and/or DFT sizes may be applied. A WTRU may receive configuration information associated with one or more OFDM symbols if configurations for the one or more OFDM symbols (e.g., which may be associated with a CORESET) are different from each other. FIGS. 17A and 17B show examples of code domain CCE multiplexing. As shown in FIG. 17A, two CCEs may be multiplexed on the same time and frequency resources using an OCC length (e.g., indicative of a spreading factor or a number of OCC codes) of two. As shown in FIG. 17B, four CCEs may be multiplexed on the same time and frequency resources using an OCC length of four. A (e.g., each) CCE may be spread by an OCC code from a set of OCC codes of a given length. A larger OCC length may increase the multiplexing capacity while decreasing the capacity (e.g., in terms of the number of modulated symbols that may be mapped) available to each individual CCE. For example, as shown in FIGS. 17A and 17B, increasing the spreading factor from two to four may reduce a CCE size (e.g., the mapping of the CCE may be reduced from 120 REs or the equivalent of 10 PRBs to 60 REs or the equivalent of 5 PRBs).

A CCE may be defined or configured in terms of one or more resource groups (RGs). A RG as described herein may be different than a REG (e.g., which may be used in the context of DMRS multiplexing in the frequency domain). A time resource element (TRE) as described herein may include a non-integer (e.g., fractional) number of time units (e.g., OFDM symbols) and may correspond to an IDFT or IFFT output sample. A DFT input sample may correspond to one or more TREs based on the relationship between DFT and IFFT module sizes. A modulated symbol in the time domain may (e.g., due to DFT coding or precoding) be spread across multiple frequency resources (e.g., subcarriers or REs) that may be allocated to a (e.g., single) DFT module. A (e.g., each) DFT module may be associated with a (e.g., single) frequency resource group (FRG) that may include or span one or more subcarriers (e.g., an FRG may include N_{DFT}^{sc} subcarriers, contiguous or non-contiguous, that may be associated with one or more TREs). Other terminology may be used instead of an RG, TRE and/or FRG to represent the same concepts.

An RG may be used to carry a portion or all of a modulated data symbol associated with a CCE (e.g., the symbol may be represented as N_{symb}). An RG may include one or more TREs, each of which may correspond to a portion (ρ) or a fraction of an OFDM symbol. An (e.g., each) RG may include or span over multiple frequency resource elements associated with a (e.g., single) DFT module. The total number of sub-carriers (e.g., frequency resources) allocated for a (e.g., single) DFT module may be equal to the DFT size (e.g., a number of frequency domain samples after pre-coding). The total number of time resources (e.g., TREs) associated with a (e.g., single) DFT module may be equal to the number of time domain (e.g., before pre-coding) samples times the ratio of an IFFT size to a DFT size. The total number of time-frequency resources allocated to the RG(s) associated with a CCE may correspond to a CCE size and/or may be defined in terms of the number of TREs and FRGs included in the CCE. For example, a CCE may be associated with

$${N}_{R G}^{CCE}$$

resource groups spanning

$${N}_{FRG}^{CCE}$$

frequency resource groups and/or

$${N}_{TRE}^{CCE}$$

time resource elements. A (e.g., each) RG may be allocated

$${N}_{tf}^{R G}$$

time-frequency resources (e.g.,

$${N}_{tf}^{R G} = ( {N}_{FRG}^{CCE} \times {N}_{TRE}^{CCE} ) / {N}_{R G}^{CCE} ,$$

assuming equal DFT sizes and/or equal RG sizes). The unit (e.g., minimum unit) of time-frequency resource in an RB may be one FRG and one TRE.

In an example where a CCE size may be equal to 54 REs (e.g., 54 modulated symbols) and two DFT modules may be used

$$( e . g . , {N}_{FRG}^{CCE} = 2 ) ,$$

and where each DFT may be associated with a frequency resource group of size

$${N}_{D F T , 1}^{s c} = {N}_{DFT , 2}^{s c} = 0.25 \times {N}_{IFFT} ,$$

and where N_{IFFT} may represent an IFFT module size, the total number of time-frequency resources that may be available/used for a CCE may be determined as follows:

$${N}_{tf}^{CCE} = 54 \times \frac{{N}_{IFFT}}{{N}_{D F T . 1}^{s c}} = 54 \times 4 = 216 ,$$

where each modulated symbol may use 4 IFFT samples. Continuing with this example, for a number of resource groups

$${N}_{R G}^{CCE} = 2 per CCE ,$$

the number of time-frequency resources per RG may be determined as follows:

$${N}_{tf}^{R G} = {N}_{tf}^{CCE} / {N}_{R G}^{CCE} = ( {N}_{FRG}^{CCE} \times {N}_{TRE}^{CCE} ) / {N}_{R G}^{CCE} = 108 ,$$

where the RG may be allocated

$${N}_{TRE}^{CCE} = {N}_{tf}^{CCE} / {N}_{FRG}^{CCE} = 108$$

resources, the RGs may be associated with a DFT module, and the RG may carry

$$54 / {N}_{R G}^{CCE} = 27 REs$$

or modulated symbols. An allocated TRE for a CCE may span one or more OFDM symbols or a fraction p of an OFDM symbol.

The size of an RG and/or the number of RGs associated with a CCE may depend on one or more of the following: a DFT size

$$( {N}_{DFT}^{s c} ) ,$$

a CCE multiplexing pattern (e.g., in the frequency/time/code domains), a number of allocated frequency resource groups

$$( {N}_{F R G}^{CCE} )$$

for the CCE, and/or a number of allocated TRES

$$( {N}_{TRE}^{CCE} )$$

for the CCE. The RGs that may belong to the CCE may have different sizes or a same size, for example, depending on the DFT size and the CCE multiplexing pattern.

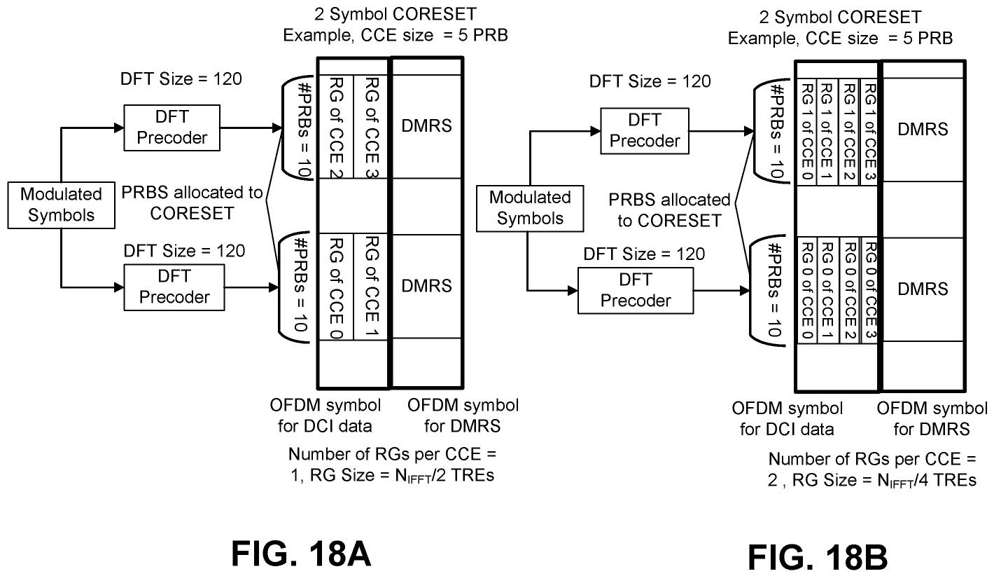

FIGS. 18A and 18B show example numbers of RGs per CCE based on a CCE multiplexing pattern. As shown in the examples, a CCE size may be 60 REs (e.g., modulated symbols) and a DFT size may be 120

$$( e . g . , {N}_{DFT}^{s c} = 120 ) .$$

As shown in FIG. 18A, there may be (e.g., only) two RGs/CCEs multiplexed in the time domain within a DFT operation

$$( e . g . , {N}_{M u x}^{DFT} = 2 ) .$$

The number of TREs in each RG or CCE per FRG (e.g., DFT module) may be determined as follows:

$${N}_{tf}^{CCE} / {N}_{F R G}^{CCE} = \frac{{N}_{IFFT}}{{N}_{M u x}^{DFT}} = \frac{{N}_{IFFT}}{2} ,$$

where the RG or CCE may be allocated half of the TREs per FRG per OFDM symbol. In some examples, half of the TREs may correspond to 60 modulated symbols

$$( e . g . , {N}_{s y m b} \times \frac{{N}_{IFFT}}{{N}_{DFT}^{s c}} = \frac{{N}_{IFFT}}{2}$$

resulting

$${N}_{s y m b} = \frac{{N}_{DFT}^{s c}}{2} = 60 ) ,$$

in which may lead to a determination that a single RG may be used per CCE

$$( e . g . , {N}_{R G}^{CCE} = \frac{CCE size}{{N}_{s y m b}} = 1 )$$

based on the configured CCE size.

As shown in FIG. 18B, there may be four CCEs multiplexed in the time domain within a DFT operation

$$( e . g . , {N}_{M u x}^{DFT} = 4 ) .$$

The number of IREs of a RG or CCE per FRG (e.g., DFT module) may be determined as follows:

$${N}_{t f}^{CCE} / {N}_{F R G}^{CCE} = \frac{{N}_{IFFT}}{{N}_{M u x}^{DFT}} = \frac{{N}_{IFFT}}{4} ,$$

where the RG or CCE may be allocated one quarter of the TREs per FRG per OFDM symbol. In some examples, one quarter of the TREs may correspond to 30 modulated symbols

$$( e . g . , {N}_{s y m b} \times \frac{{N}_{IFFT}}{{N}_{DFT}^{s c}} = \frac{{N}_{IFFT}}{4}$$

resulting in

$${N}_{s y m b} = \frac{{N}_{DFT}^{s c}}{4} = 30 ) ,$$

which may lead to a determination that two RGs may be used per CCE

$$( e . g . , {N}_{R G}^{CCE} = \frac{CCE size}{{N}_{s y m b}} = 2 )$$

based on the configured CCE size. As shown in FIG. 18B, the two RGs of a CCE may be allocated different frequency locations (e.g., FRGs) with different DFT pre-coding blocks.

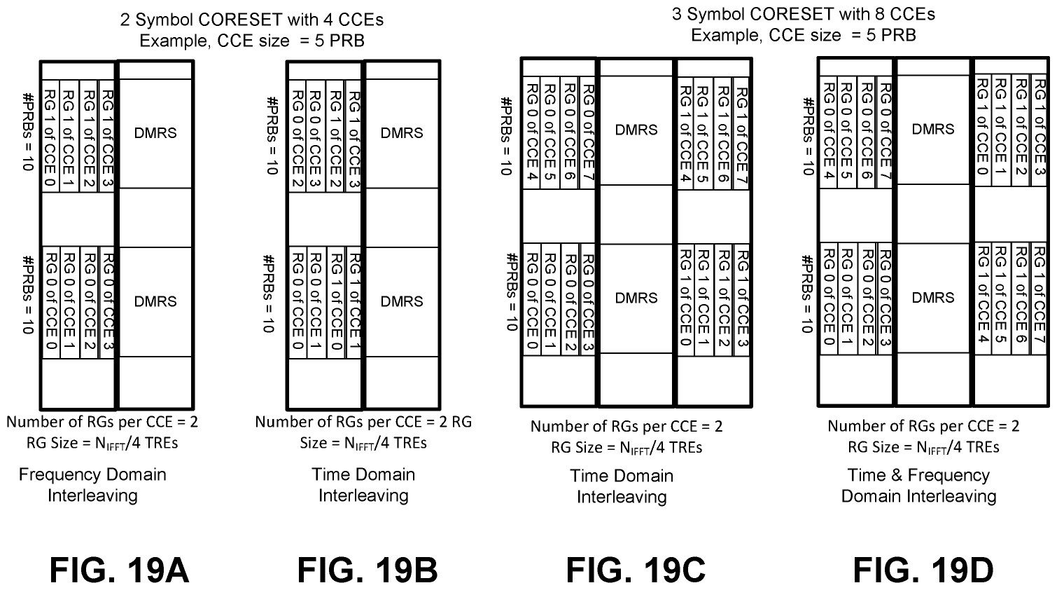

The RGs of a CCE may be interleaved in time and/or frequency domains. FIGS. 19A-19D show examples of different RG-to-CCE interleaving scenarios in time and/or frequency domains. The examples in FIGS. 19A and 19B show a 2-symbol CORESET with four CCEs multiplexed using two FRGs (e.g., DFTs), each of size 10 PRBs and with one OFDM symbol allocated for the PDCCH, where each CCE may be allocated five PRBs and split into 2 RGs. FIG. 19A illustrates an example of frequency domain interleaving and FIG. 19B illustrates an example of time domain interleaving. As shown in FIG. 19A, each of 4 CCEs may be spread across two FRGs (e.g., across the frequency domain over two different DFTs, where the CORESET frequency allocation may or may not be contiguous) with two RGs allocated to each CCE. As shown in FIG. 19B, each pair of CCEs may be dedicated to a single FRG (e.g., DFT module) and the corresponding RGs may be interleaved in time.

FIGS. 19C and 19D illustrates a 3-symbol CORESET with 8 CCEs multiplexed using two FRGs (e.g., DFTs), each of size 10 PRBs and with two OFDM symbols allocated for the PDCCH, where each CCE may be allocated 5 PRBs and split into 2 RGs. FIG. 19C shows an example of time domain interleaving and FIG. 19D shows an example of combined time and frequency domain interleaving. As shown in FIG. 19C, each of the 8 CCEs may be dedicated to a single FRG (e.g., 4 CCEs are time domain multiplexed within a single FRG) and the two corresponding RGs may be allocated to different OFDM symbols. As shown in FIG. 19D, the two RGs corresponding to a single CCE may be allocated different FRGs and OFDM symbols (e.g., allocated to different DFT modules and at different times). For example, a first RG (e.g., RG 0) of a first CCE (e.g., CCE 0) may include a first FRG (e.g., FRG 0) at a first OFDM symbol (e.g., allocated for the PDCCH) whereas a second RG (e.g., RG 1) of the first CCE may include a second FRG (e.g., FRG 1) at a second OFDM symbol (e.g., allocated for the PDCCH).

A WTRU may receive DL control information associated with a DFT spread channel. The WTRU may report or receive WTRU capability information, CORESET configuration information, and/or search space configuration information. The WTRU may report its hardware and/or processing conditions or capabilities (e.g., complexity, power consumption, latency, etc.) in consideration of additional overhead (e.g., in terms of processing complexity and/or processing latency) that may be imposed on control channel detection at the WTRU due to use of a DFT-s-OFDM waveform. The capability information reported by the WTRU may indicate one or more of the following: a maximum number of DFT modules, a DFT size, a maximum number of PDCCH candidates, a maximum number of non-overlapped CCEs, and/or a combination of a PDCCH monitoring span and a PDCCH monitoring group. The WTRU may indicate or report the aforementioned information to a network (e.g., a base station), for example, during a registration process or as part of a WTRU capability indication (e.g., the capability of monitoring for a PDCCH). The WTRU may indicate or report a supported (e.g., maximum) number of DFT modules (e.g., transform precoders) per symbol, per slot, and/or per serving cell. The WTRU may repot an integer indicating a number of FRGs (e.g., DFTs), N_{FRG}, that may be monitored by the WTRU. The WTRU may indicate or report one or more DFT module sizes supported by the WTRU. For example, the WTRU may report an integer indicating the maximum DFT or FRG size

$$( e . g . , {N}_{DFT}^{s c} )$$

supported by the WTRU in terms of sub-carriers or resource blocks. The WTRU may indicate or report a maximum number of PDCCH candidates per symbol, per slot, and/or per serving cell that may be decoded by the WTRU (e.g., for a given numerology) and/or one or more DFT sizes supported by the WTRU. For example, the WTRU may report one or more integers indicating respective (e.g., maximum) number of PDCCH candidates, N_{pdcch}^{candidates}, that may be associated with one or more DFT module sizes (e.g., at a specified numerology) supported by the WTRU (e.g., in a slot). The WTRU may indicate or report a maximum number of PDCCH candidates per symbol, per slot, and/or per serving cell that may be decoded by the WTRU for one or more number of DFT modules supported by the WTRU (e.g., per symbol/slot). The WTRU may indicate or report a maximum number of non-overlapped CCEs in the time domain and/or the frequency domain per symbol, per slot, and/or per serving cell for one or more DFT sizes supported by the WTRU. The WTRU may indicate or report a maximum number of non-overlapped CCEs in the time domain and/or the frequency domain per symbol, per slot, and/or per serving cell for one or more number of DFT modules supported by the WTRU (e.g., per symbol/slot). The WTRU may indicate or report one or more PDCCH monitoring span/group combinations (X, Y) supported by the WTRU for one or more DFT sizes and/or number of DFT modules (e.g., per symbol/slot or across multiple symbols/slots). Parameter X may be a minimum separation (e.g., in terms of number of symbols) between the first symbols of two consecutive spans of PDCCH monitoring occasions (e.g., including across slots), while parameter Y may be the number of symbols of the span. The span may start at a first symbol where a PDCCH monitoring occasion may start and may end at a last symbol where the PDCCH monitoring occasion may end (e.g., the number of symbols of the span may be up to Y). The network may limit the number and/or configuration of PDCCH candidates to be monitored (e.g., blindly detected) by the WTRU based on the aforementioned information (e.g., one or more of the parameters described herein) provided by the WTRU.

A WTRU may receive, from a network device such as a base station, configuration information regarding a CORESET (e.g., as part of ControlResourceSetZero and/or ControlResourceSet). The configuration information may be received, for example, using higher layer signaling, such as, e.g., RRC signaling or system information. The configuration information may indicate one or more of a CORESET index, a time domain configuration, a frequency domain configuration, a configuration of DMRS for a PDCCH, a CCE structure, a precoder granularity, an indication of CCE aggregation levels, and/or a number of PDCCH candidates. The time domain configuration described herein may indicate a short or long format for an allocate pattern of OFDM symbols (e.g., such as the number of allocated OFDM symbols and/or an indication of the indices of those OFDM symbols). The number of allocated OFDM symbols may be indicated explicitly or implicitly. For example, a short format 1 may be used to indicate an allocation of two OFDM symbols to a PDCCH and/or a DMRS for the PDCCH, a short format 2 may be used to indicate an allocation of three OFDM symbols to the PDCCH and/or a DMRS for the PDCCH, and so on. As another example, a long format 1 may be used to indicate an allocation of four OFDM symbols to the PDCCH and/or a DMRS for the PDCCH, a long format 2 may be used to indicate an allocation of five OFDM symbols to the PDCCH and/or a DMRS for the PDCCH, and so on. In some examples, an indication may be provided for the indices of OFDM symbols within a slot that may be dedicated to the PDCCH and/or a DMRS for the PDCCH. For example, an OFDM symbol index may be used to indicate the starting symbol of a CORESET within a slot.

The frequency domain configuration described herein may indicate a resource block (RB) offset and/or a frequency domain resource. For example, the frequency domain configuration may include a resource block (RB) offset from the first RB allocated to a CORESET to the first RB of a corresponding bandwidth part (BWP). The frequency domain configuration may include frequency domain resources allocated for the CORESET, which may correspond to contiguous or non-contiguous resource allocation. The resources may be indicated in terms of RBs, a group of RBs, and/or FRGs.

The configuration for a DMRS for a PDCCH as described herein may include one or more of an indication of an additional DMRS configuration, a mapping/location of OFDM symbols allocated to the DMRS, an indication of frequency resources, an indication of DMRS sequence parameters, a DMRS modulation type, and/or additional DMRS configuration parameters. The DMRS configuration described herein may include a mapping/location of OFDM symbols allocated to the DMRS, which may be indicated explicitly and/or implicitly. For example, the locations of the OFDM symbols may be indicated (e.g., explicitly) as a set of indices with respect to the first OFDM in a slot containing the CORESET or the first OFDM symbol in the CORESET. The locations of the OFDM symbols may be indicated (e.g., explicitly) as an index to an OFDM symbol and/or a number of (e.g., consecutive) OFDM symbols allocated to the DMRS. For example, the locations of the OFDM symbols may be indicated (e.g., implicitly) based on a set of preconfigured patterns that may be dependent on a time domain configuration of a CORESET and/or an additional DMRS indication. The DMRS configuration may include an indication of frequency resources (e.g., REs/RBs) that may be considered for the transmission of the DMRS within one of the dedicated OFDM symbols, for example, if a subset of REs and/or RBs within the bandwidth of the CORESET are configured for DMRSes. For example, the frequency domain configuration of resources selected to transmit the DMRS associated with the CORESET may be indicated (e.g., implicitly) based on a set of preconfigured patterns that may be dependent on RE indices within an RB and/or RB indices within a BWP (e.g., associated with the CORESET) selected to transmit the DMRS. The DMRS configuration may include an indication of DMRS sequences parameters, such as, e.g., one or more of a sequence type, an initializing seed, a cyclic shift, a base sequence, etc. The DMRS configuration may include a DMRS modulation type, a spreading factor, and/or an orthogonal sequence index.

The CCE structure, interleaving, and/or multiplexing configuration described herein may indicate one or more of a CCE size, a number of RGs per CCE and/or the corresponding RG sizes, a number of FRGs, an indication of interleaving, an indication of time and/or code domain multiplexing schemes, an indication of orthogonal codes, etc. The CCE size may be defined in terms of a number of modulated symbols and/or a number of REs/RBs. The CCE size may be fixed (e.g., preconfigured at a base station and/or a WTRU) or configurable. A configurable CCE size may be signaled (e.g., explicitly), for example, as part of the CORESET configuration, or it may be derived or determined based on other CORESET parameters, such as, e.g., frequency domain and/or multiplexing configurations.

The CORESET configuration information described herein may indicate a CCE and/or a number of RGs (e.g., with corresponding RG sizes) associated with the CCE. The RG size(s) associated with a CCE may be (e.g., explicitly) signaled/indicated to a WTRU, or they may be derived/determined based on other CORESET configuration parameters, such as, e.g., a CCE size, a number of RGs per CCE, a multiplexing configuration, etc. The CORESET configuration information described herein may indicate a number of FRGs (e.g., a number of DFTs per CORESET) and/or a size of an (e.g., each) FRG (e.g., in terms of a number of sub-carriers). The CORESET configuration information described herein may may include an indication of an interleaving scheme, interleaving size(s) in time and/or frequency domains, a cyclic shift, and/or an indication of RG or CCE ordering. For example, the configuration information may indicate that a number RGs or CCEs may be interleaved in time first and then in frequency, or that the number of RGs or CCEs may be interleaved in frequency first and then in time. The CORESET configuration information described herein may include an indication of time and/or code domain multiplexing schemes (e.g., per FRG and/or OFDM symbol). The CORESET configuration information described herein may indicate the number of multiplexed RGs or CCEs per FRG. The multiplexing may be performed over one or more OFDM symbols (e.g., including a non-integer number of OFDM symbols). The CORESET configuration information described herein may include an indication of orthogonal (e.g., cover) codes and/or their corresponding lengths (e.g., spreading factors if/when code domain multiplexing is indicated).

The CORESET configuration information described herein may include an indication of a precoder granularity. The precoder granularity may be configured, for example, as sameAsFRG or allContiguousRBs. The precoder granularity may be configured as sameAsFRG if/when the same precoding weights are applied to multiple (e.g., all) RBs associated with a FRG or a DFT module (e.g., different precoding weights may be applied to RBs belonging to different FRGs). The precoder granularity may be configured as allContiguousRBs if/when the same precoding weights are applied to multiple (e.g., all) RBs belonging to contiguous RBs. The CORESET configuration information described herein may include an indication of one or more CCE aggregation levels and/or a number of PDCCH candidates for an (e.g., each) indicated aggregation level.

A WTRU may receive, from a network device such as a base station, configuration information regarding a search space. The configuration information may be received, for example, as part of SearchSpaceZero and/or SearchSpace (e.g., using higher layer signaling such as RRC signaling or system information). The search space configuration information may indicate one or more of a CORESET index, a PDCCH monitoring periodicity and/or offset, a PDCCH monitoring pattern, a duration, an indication of CCE aggregation levels, a search space type, and/or frequency monitoring locations. The CORESET index may indicate an associated CORESET. The PDCCH monitoring periodicity and/or offset may be defined in terms of an integer number of slots. The PDCCH monitoring pattern may be associated with a slot and may indicate one or more symbols (e.g., integer or non-integer number of symbols) within the slot that may be used for PDCCH monitoring. The duration may indicate a number of (e.g., consecutive) slots associated with the search space. The search space type may be set to common or WTRU-specific, and the DCI formats that may be carried using the search space may be configured. The frequency monitoring locations may define an association of the search space to multiple monitoring locations in the frequency domain, and may indicate whether the pattern configured in the associated CORESET may be replicated to a specific RB or FRG set. A bitmap may be used for the indication, in which each bit may correspond to an RB or FRG set. The leftmost (e.g., most significant) bit may correspond to RB/FRG set 0 in a BWP. A bit with a value of 1 may indicate that a frequency domain resource allocation replicated from the pattern configured in the associated CORESET may be mapped to the RB/FRG set.

Different CCE structure configurations, interleaving configurations, and/or multiplexing configurations (e.g., for a given time-frequency allocation or configuration of a CORESET) may be derived and used. These configurations may indicate, for example, a number of FRGs or DFTs associated with a CORESET or CCE, a FRG or DFT size, a number of CCEs multiplexed in the time/code domains per FRG or DFT within an OFDM symbol, a RG interleaving pattern, etc. The configurations may be provided based on a variety of criteria or factors, including, for example, one or more of network (e.g., base station) energy efficiency, an CCE aggregation level, frequency domain diversity, time domain diversity, a precoding technique, WTRU complexity or capability, control channel congestion conditions, etc.

With respect to network (e.g., base station) energy efficiency, a PAPR may be inversely proportional to a DFT size and/or directly proportional to the number of DFT pre-coders used for a given bandwidth allocation (e.g., contiguous or non-contiguous PRBs). A configuration with a higher number of DFT pre-coders (e.g., with smaller DFT sizes) applied to the allocated PRBs in an OFDM symbol may be associated with a higher PAPR (e.g., lower BS energy efficiency), while a configuration with a smaller number of DFT pre-coders (e.g., with larger DFT sizes) may be associated with higher energy efficiency. A lower PAPR may be associated with improved network coverage.

With respect to a CCE aggregation level, a WTRU may be allocated multiple CCEs (e.g., CCE aggregation level >1) to improve coverage conditions. The CCE aggregation may be performed in the time domain (e.g., within one or more OFDM symbols), for example, in noise limited scenarios or relatively fast fading channel scenarios. The CCE aggregation may be performed in the frequency domain (e.g., within one or more OFDM symbols), for example, for frequency selective fading over the allocated bandwidth of a CORESET.

With respect to frequency domain diversity, the diversity may be helpful for frequency selective fading. CCEs allocated to a WTRU and/or RGs associated with a CCE of the WTRU may be interleaved in the frequency domain within one or more OFDM symbols to achieve the frequency diversity. CCEs allocated to the WTRU and/or RGs associated with a CCE of the WTRU may be interleaved and/or aggregated in the frequency domain using distributed (e.g., different/separate) DFT pre-coders and/or clustered DFT pre-coding.

With respect to time domain diversity, the diversity may be helpful for a fast fading channel (e.g., with a channel coherence time in the order of one or more OFDM symbols). CCEs allocated to a WTRU and/or RGs associated with a CCE allocated to the WTRU may be interleaved and/or aggregated in the time domain across one or more OFDM symbols to achieve the time diversity.

With respect to precoding, constraints may be imposed (e.g., at a transmitter). The same precoding may be applied to multiple (e.g., all) data within an OFDM symbol mapped using a DFT pre-coder. For example, the same precoding weights may be applied to multiple (e.g., all) CCEs or RGs multiplexed in the time/code domain, e.g., after a DFT pre-coding within a OFDM symbol. The CCEs or RGs may belong to one or more WTRUs.

With respect to WTRU complexity and/or capability, different WTRUs may have different capabilities in terms of the number of DFT pre-coders and/or corresponding DFT sizes per OFDM symbol/slot/serving cell supported by the WTRUs. Blind decoding may generate a processing load at a WTRU. DFT decoding at the WTRU side (e.g., to extract PDCCH information) may incur processing time and/or overhead. A maximum number of PDCCH candidates and/or a maximum number of CCEs associated with channel estimation per slot or serving cell with a DFT pre-coded PDCCH (e.g., as a function of sub-carrier spacing) may be configured for a WTRU.

With respect to control channel congestion, a moderate CCE aggregation level and/or a higher granularity for precoding with frequency diversity (e.g., using distributed or clustered DFT pre-coding within one or more OFDM symbols) may be selected at the expense of reduced or lower network energy efficiency (e.g., due to higher PAPR) in order to reduce a control channel blocking probability. In some examples, a higher aggregation level and/or lower granularity precoding with time domain multiplexing via a larger DFT pre-coding may be used to achieve higher network energy efficiency (e.g., a lower PAPR) at the expense of a higher blocking probability (e.g., assuming the current configuration has lower frequency diversity compared to a previous configuration and/or lower CCE decoding performance that may be caused by squeezing CCE modulated symbols into a shorter period of time).

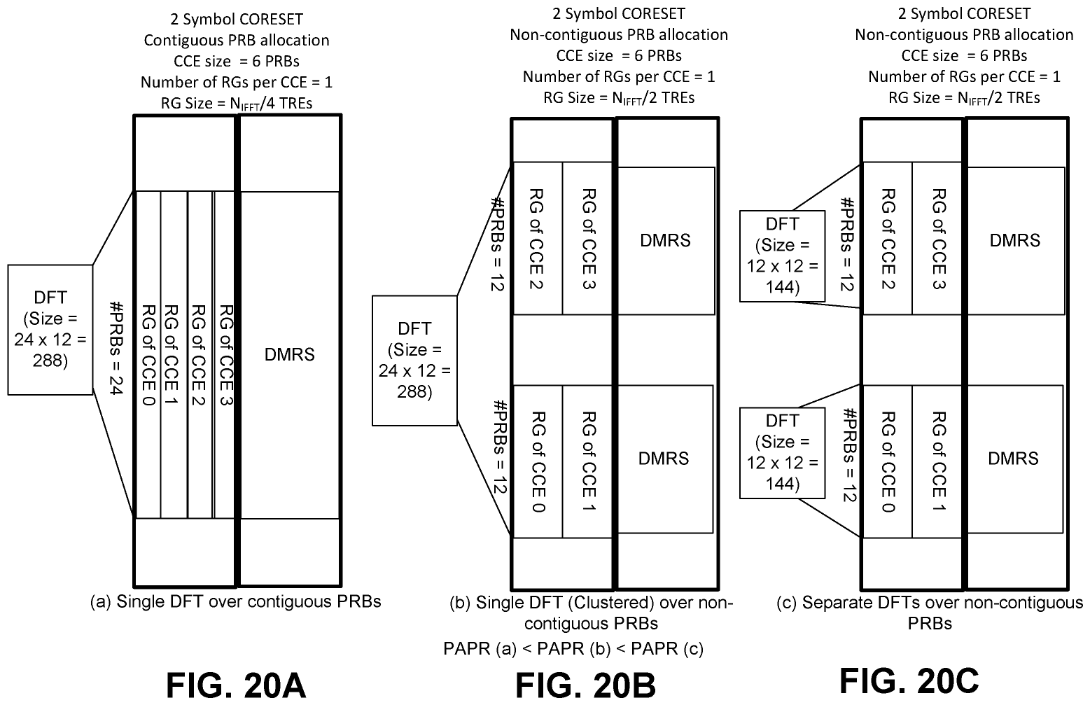

FIGS. 20A-20C show examples of a two-symbol CORESET with 24 PRBs with contiguous and non-contiguous PRB allocations. FIGS. 20B and 20C show examples of non-contiguous allocations, wherein a single DFT pre-coder (e.g., clustered DFT pre-coder) or separate DFT pre-coders may be applied for the non-contiguous allocation. FIG. 20A shows the lowest PAPR out of the three example scenarios illustrated by FIGS. 20A-20C. The example scenario shown in FIG. 20B may have lower PAPR performance than the example scenario shown in FIG. 20C.

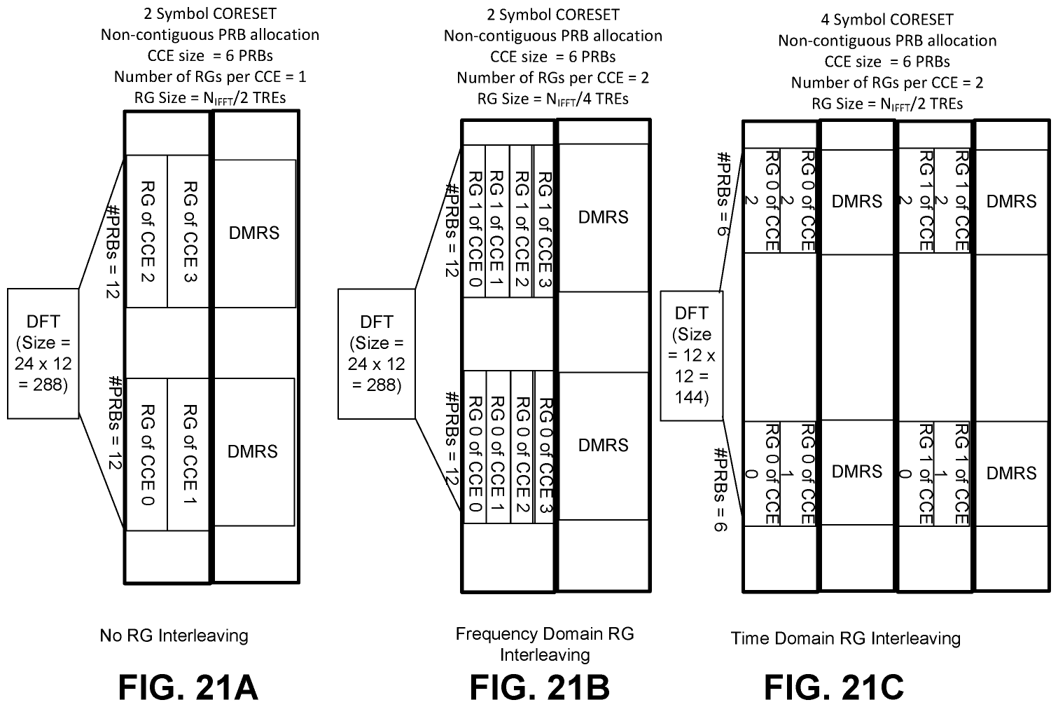

FIGS. 21A-21C show examples of CORESET configurations with non-contiguous PRB allocations with different scenarios of RG interleaving. FIG. 21A shows an example of a two-symbol CORESET without RG interleaving. FIG. 21 B shows an example of a two-symbol CORESET with frequency domain RG interleaving (e.g., to achieve better frequency diversity). FIG. 21C shows an example of a four-symbol CORESET with time domain interleaving across different OFDM symbols (e.g., to achieve better time diversity).

A WTRU may receive configuration information that may be used to receive a DL control channel transmission (e.g., a PDCCH transmission including downlink control information). Based on the configuration information, the WTRU may determine (e.g., for each DL BWP configured for the WTRU in a serving cell) a time domain configuration that may indicate the starting symbol indices, slot indices, and/or frame indices to be monitored by the WTRU to receive the PDCCH transmission. For example, the WTRU may determine, based on the configuration information, one or more of a PDCCH monitoring periodicity and/or offset, a PDCCH monitoring pattern, and/or a PDCCH monitoring duration. The configuration information may be provided, for example, as part of a search space configuration described herein. Given a frame, slot, and/or starting symbol, the WTRU may determine the number of (e.g., consecutive) OFDM symbols in an associated CORESET that may be used to carry a PDCCH transmission and/or a DMRS transmission. For a time-domain span such as the consecutive OFDM symbols associated with the CORESET, the WTRU may determine a time domain allocation pattern and/or a mapping of PDCCH data (e.g., DCI) and/or DMRS transmissions to symbols. The allocation pattern and/or mapping may indicate which symbols may be dedicated for DMRS and/or DCI data transmissions, such as, e.g., the locations of the OFDM symbols allocated to a DMRS, a pattern index selected from a set of preconfigured patterns, and/or additional DMRS configurations that may be provided in an associated CORESET configuration.

The WTRU may (e.g., for each DL BWP configured for the WTRU in a serving cell) determine a frequency domain configuration that may indicate a contiguous or non-contiguous set of RBs associated with the OFDM symbols allocated for a PDCCH transmission. The WTRU may monitor for the PDCCH transmission according to the frequency domain configuration (e.g., which may be provided in a CORESET configuration) and/or the frequency monitoring locations that may be provided in an associated search space. The WTRU may determine the frequency domain configuration for purposes of receiving the PDCCH transmission or for channel estimation. The WTRU may use the frequency domain configuration to decode the PDCCH transmission (e.g., according to an indication of the frequency resources allocated for a DMRS and/or a pattern index selected from a set of preconfigured patterns that may be provided in an associated CORESET configuration). The WTRU may (e.g., for channel estimation) determine a DMRS sequence according to configuration parameters including, for example, a sequence type, an initializing seed, a cyclic shift, and/or a base sequence, which may be provided in an associated CORESET configuration. The WTRU may (e.g., for channel estimation) determine the frequency selectivity of precoding applied by the network according to a precoding granularity that may be provided in an associated CORESET configuration.

A WTRU may determine a CCE allocation pattern that may indicate an association or mapping between CCE indices and time-frequency resources (e.g., OFDM symbols and FRGs) of a CORESET associated with a PDCCH transmission. The WTRU may determine the CCE allocation pattern according to configuration parameters that may include a CCE structure configuration, an interleaving configuration, and/or a multiplexing configuration (e.g., which may be provided as part of a CORESET configuration).

Time division multiplexing (which may also be referred to as time domain multiplexing) may be applied to a downlink transmission. A WTRU may be provided with configuration information that may indicate at least one of a CCE size (e.g., as a number of modulated symbols or REs), a number of RGs per CCE (N_{RG}^{CCE}), a number of FRGs (e.g., DFTs) and their associated sizes (N_{DFT}^{sc}), an indication of time domain multiplexing, an indication of time domain interleaving and/or an associated interleaving size, an indication of frequency domain interleaving and/or an associated interleaving size, etc. The configuration information may be provided, for example, as a part of a CORESET configuration. An FRG may be assigned an index, for example, if there are multiple FRGs. The index may be provided based on the order of the relative locations of the FRGs in the frequency domain. For example, a first index (e.g., index 0) may be assigned to the FRG that may include the REs/RBs located first/lowest (e.g., compared to the other FRGs) within a CORESET or BWP, a second index (e.g., index 1) may be assigned to the FRG that may include a next set of REs or RGs located in the CORESET or BWP, and so on. The WTRU may (e.g., based on a configuration setting) perform one or more of the following actions.

The WTRU may (e.g., in action 1) determine an RG size (N_{Symb}) associated with a (e.g., each) CCE, for example, based on the CCE size and/or the number of RGs per CCE,

$${N}_{Symb} = \frac{CCE Size}{{N}_{R G}^{C C E}} .$$

The WTRU may (e.g., in action 2) determine the number of RGs multiplexed in the time domain for an (e.g., each) FRG,

$${N}_{Mux}^{DFT} = \frac{{N}_{DFT}^{sc}}{{N}_{Symb}} , where {N}_{DFT}^{sc}$$

may be the size of the corresponding FRG/DFT. The WTRU may (e.g., in action 3) determine the number of TREs per TRE block (e.g., number of TREs associated with each RG) as N_{symb} times the ratio of an IFFT module size to a DFT module size. The IFFT module size may be configured or signaled, for example, via higher layer signaling (e.g., RRC or SI). The WTRU may (e.g., in action 4) determine the number of TRE blocks within a FRG as the product of the determined

$${N}_{Mux}^{DFT}$$

and the number of OFDM symbols allocated for DCI. A TRE block associated with an RG may be assigned an index, e.g., for each FRG. The index numbering may increase within the same OFDM symbol (e.g., starting from the lowest OFDM symbol carrying DCI data). The index numbering may increase (e.g., continuously) across OFDM symbols (e.g., if multiple OFDM symbols are allocated for DCI). In an example where two OFDM symbols are allocated for DCI, each with 4 RGs, a first OFDM symbol may be associated with TRE block 0, TRE block 1, TRE block 2, and TRE block 3 respectively allocated for a first RG, a second RG, a third RG, and a fourth RG in the first OFDM symbol, while a second OFDM symbol may be associated with TRE block 4, TRE block 5, TRE block 6, and TRE block 7 respectively allocated for the first RG, the second RG, the third RG, and the fourth RG in the second OFDM symbol. The WTRU may (e.g., in action 5) determine an RG interleaving or allocation pattern across OFDM symbols (TREs) and FRGs, for example, according to time domain and/or frequency domain interleaving sizes. The WTRU may (e.g., in action 6) determine the CCE(s) (e.g., indices of the CCE(s)) associated with an aggregation level L (e.g., corresponding to a PDCCH candidate indicated in a search space) based on Equation (1) described herein.

An RG interleaving or allocation pattern across OFDM symbols (e.g., TREs) and FRGs may be determined according to time domain interleaving. A time domain interleaver size may be represented by M (e.g., greater than or equal to 1), while a frequency domain interleaver size may be represented by N (e.g., equal to 1). The total number of TRE blocks may be divided into M sections (e.g., for each DFT module) based on time and/or frequency domain interleaver size indications or a lack thereof. The RGs associated with CCEs may be mapped to time-frequency resources (e.g., first in the time domain and then in the frequency domain), for example, if/when the number of FRGs/DFTs is greater than one. The mapping may start with the lowest CCE index (e.g., CCE 0), and the RGs associated with the CCE (e.g., starting with the first RG of the CCE) may be mapped in the time domain to TRE blocks (e.g., by rotating around M sections in an increasing order of TRE block indices within a first FRG). The mapping may move upwards in the frequency domain to map to the TRE blocks associated with a second FRG in the same manner, and so on.

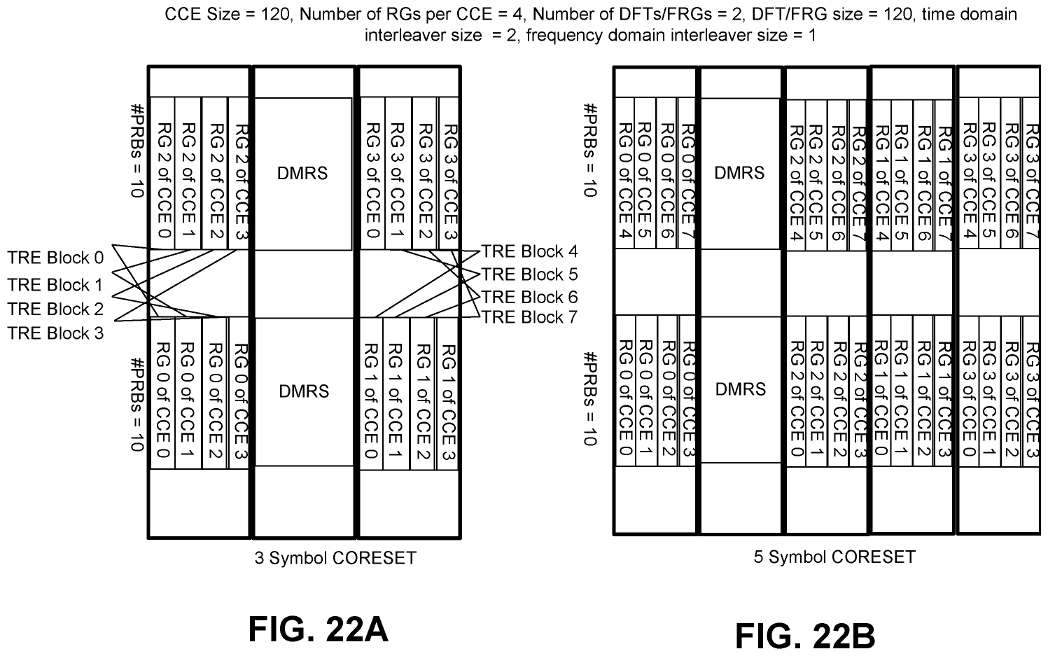

FIGS. 22A and 22B show examples of RG mappings based on time-domain interleaving. In the examples, a CCE size is set to 120, the number of RGs per CCE is set to 4, the number of DFTs is set to 2 (e.g., each with a size of 120), M is set to 2, and N is set to 1. FIG. 22A shows an example of a three-symbol CORESET, where one OFDM symbol (e.g., the second symbol) is allocated for a DMRS and two OFDM symbols are dedicated for DCI data (e.g., the value of M may be two). The mapping of the RGs may be rotated over the TREs of two OFDM symbols, where each OFDM symbol may have four TRE blocks. The WTRU may determine, based on the number of OFDM symbols, the number of DFTs, DFT sizes, and/or CCE sizes, that a total of four CCEs may be multiplexed within a given CORESET. The RGs of each CCE (e.g., starting from the lowest index) may be mapped in the time-domain to the TREs associated with a first FRG, for example, by rotating over two sections. The mapping may then continue with the TREs of a second FRG (e.g., in the same manner), and so on.

FIG. 22B shows an example of a five-symbol CORESET with one OFDM symbol (e.g., the second symbol) allocated for a DMRS and four OFDM symbols dedicated for DCI data (e.g., the value of M may be two). The WTRU may determine, based on the number of OFDM symbols, the number of DFTs, DFT sizes, and/or CCE sizes, that eight CCEs may be multiplexed within a given CORESET. The mapping of RGs may be rotated over a first section and a second section. The first section may include the first and third OFDM symbols, while the second section may include the fourth and fifth OFDM symbols.

An RG interleaving or allocation pattern across OFDM symbols (e.g., TREs) and FRGs may be determined according to frequency domain interleaving. A frequency domain interleaver size may be represented by N (e.g., greater than or equal to 1), while a time domain interleaver size may be represented by M (e.g., equal to 1). The RGs associated with CCEs may be mapped to time-frequency resources based on time and/or frequency interleaver size indications or a lack thereof (e.g., by moving in the frequency domain first and then in the time domain), for example, if/when the number of TRE blocks is greater than one. The total number of FRGs may be divided into N sections for each TRE block. The mapping may start with the lowest CCE index (e.g., CCE 0), and the RGs associated with the CCE (e.g., starting with the first RG of the CCE) may be mapped in the frequency domain to TREs (e.g., by rotating around N sections in an increasing order of FRG indices over the first TRE block). The mapping may then moving rightwards in the time domain to map to the TREs of a second TRE block of the FRGs (e.g., in the same manner), and so on.

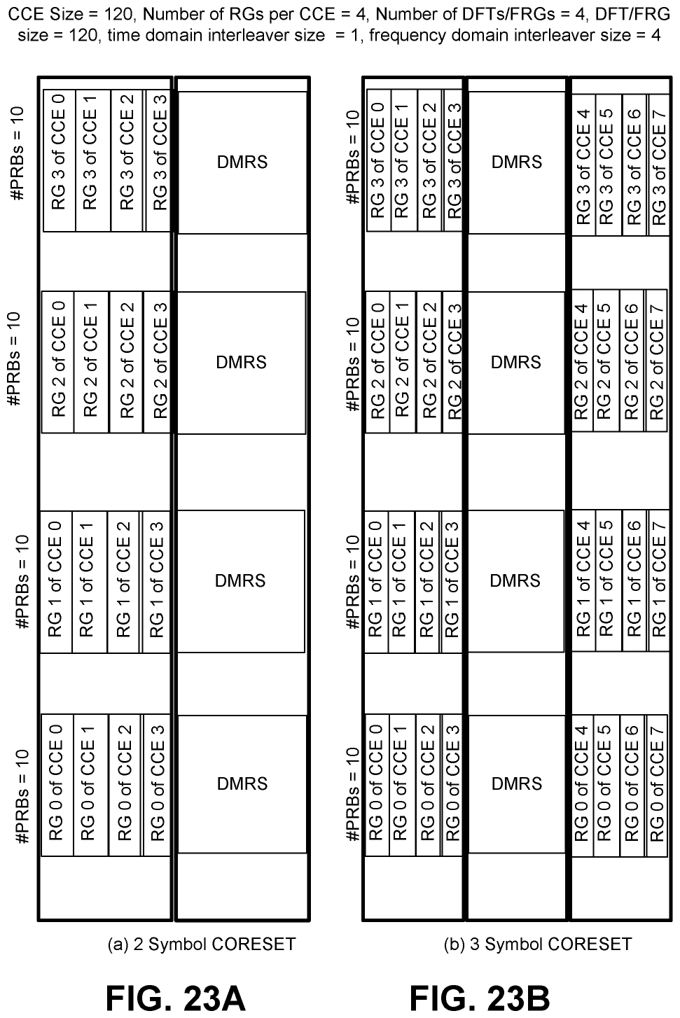

FIGS. 23A and 23B show examples of RG mappings based on frequency-domain interleaving. In the examples in FIGS. 23A and 23B, a CCE size is set to 120, the number of RGs per CCE is set to 4, the number of DFTs is set to 2 (e.g., with the same DFT size of 120), N is set to 4, and M is set to 1. FIG. 23A shows an example of a two-symbol CORESET, with one symbol (e.g., the second symbol) allocated for a DMRS, and four FRGs (e.g., the value of N may be set to four). The mapping of RGs may be rotated over the four FRGs, and the WTRU may determine, based on the number of OFDM symbols, the number of DFTs, DFT sizes, and/or CCE sizes, that four CCEs may be multiplexed within a given CORESET. The RGs of each CCE (e.g., starting from the lowest index) may be mapped in the frequency domain to a first TRE block, for example, by rotating over the four FRGs. The mapping may then continue to a second TRE block of four FRGs (e.g., in the same manner), and so on. FIG. 23B shows an example of a three-symbol CORESET, with one symbol (e.g., the second symbol) allocated for DMRS. The WTRU may determine, based on the number of OFDM symbols, number of DFTs, DFT sizes, and/or CCE sizes, that eight CCEs may be multiplexed. The four RGs of four CCEs in the first OFDM symbol may be mapped, for example, based on the method described with respect to FIG. 23A. The RGs of the remaining four CCEs may be multiplexed in the third OFDM symbol (e.g., using the same method).

An RG interleaving or allocation pattern across OFDM symbols (e.g., TREs) and FRGs may be determined according to time domain interleaving and frequency domain interleaving. A time domain interleaver size may be represented by M (e.g., greater than or equal to 1), while a frequency domain interleaver size may be represented by N (e.g., greater than or equal to 1). The total number of associated TRE blocks may be divided into M sections for a (e.g., each) DFT module. The total number of FRGs may be divided into N sections for a (e.g., each) TRE block. The RGs associated with CCEs may be mapped to time-frequency resources by moving in the time domain (e.g., if/when the number of TRE blocks is greater than 1) and in the frequency domain (e.g., if/when the number of FRGs/DFTs is greater than 1). Mapping may start with the lowest CCE index (e.g., CCE 0), and the RGs associated with the CCE (e.g., starting with the first RG of the CCE) may be mapped to TRE blocks, for example, by rotating around the M sections in an increasing order of the TRE block indices and around the N sections in an increasing order of the FRG indices (e.g., simultaneously).

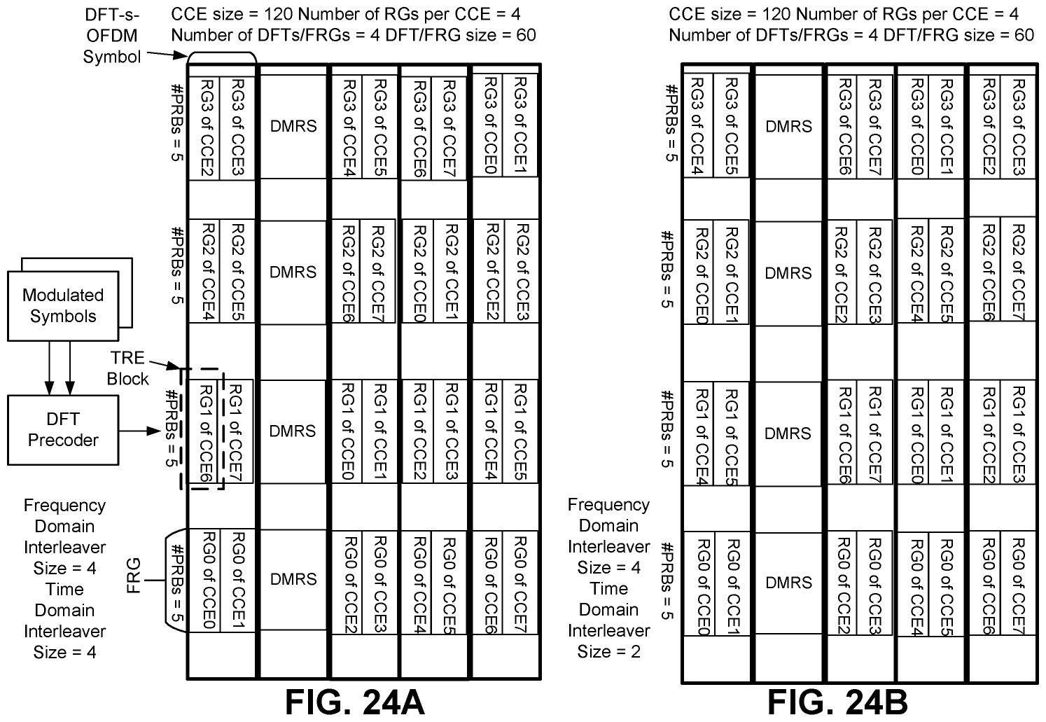

FIGS. 24A and 24B show examples of RG mappings based on time domain interleaving and frequency domain interleaving. In these examples, the CCE size is set to 120, the number of RGs per CCE is set to 4, the number of DFTs is set to 2 (e.g., with the same DFT size of 60). A WTRU may determine, based on the number of OFDM symbols, the number of DFTs, DFT sizes, and/or CCE sizes, that eight CCEs may be multiplexed within a given CORESET. FIG. 24A shows an example with M=4 and N=4. Since there may be four OFDM symbols dedicated for DCI data, and four FRGs with the values of M and N set to 4, the mapping of RGs may be rotated over TREs associated with four OFDM symbols and four FRGs (e.g., simultaneously). The RGs of each CCE, starting from the lowest index, may be mapped to the next available TRE block (e.g., with the lowest FRG). The mapping may then continue to the next TRE block (e.g., after moving to the next OFDM symbol and the next FRG following a rotation with M=N=4). FIG. 24B shows an example mapping with different values of M and N. In the example shown in FIG. 24B, M may be set to 2 and N may be set to 4. The total number of TRE blocks in the time domain may be divided into two sections, and the number of FRGs may be divided (e.g., similar to the example shown in FIG. 24A) into four sections.

A WTRU may receive a PDCCH transmission (e.g., a PDCCH candidate) and decode the DCI included in the PDCCH transmission based on the configuration information (e.g., search space and/or CORESET configuration information) described herein. The reception of the PDCCH transmission may include performing an IDFT based on the FRGs and TREs (e.g., a non-integer number of OFDM symbols) associated with the PDCCH transmission. The FRGs and/or TREs may be located (e.g., determined) based on CCE indices associated with the PDCCH transmission, the number of RGs per CCE, and/or an RG allocation pattern (e.g., in a corresponding search space or CORESET). The reception of the PDCCH transmission may include extracting (e.g., based on the determined RG size and/or RG allocation pattern) information carried in one or more TRE blocks associated the PDCCH transmission (e.g., associated with the RGs used to transmit the PDCCH transmission), and/or demodulating the symbols associated with the PDCCH transmission (e.g., associated with the RGs used to transmit the PDCCH transmission). The reception of the PDCCH transmission may further include detecting a DCI format (e.g., based on a RNTI) and/or decoding of the DCI.

A WTRU may be provided with configuration information (e.g., configuration parameters) that may indicate at least one of a CCE size, a number of RGs associated with a CCE, a number of RGs multiplexed in the time domain per FRG

$$( {N}_{Mux}^{DFT} ) ,$$

a number of FRGS (e.g., DFTs) and/or their sizes

$$( {N}_{DFT}^{sc} ) ,$$

an indication of the application of time domain multiplexing, an indication of time domain interleaving and/or its associated interleaving size, an indication of frequency domain interleaving and/or its associated interleaving size. The configuration information may be provided, for example, as part of a CORESET configuration. The WTRU may perform one or more of the following actions based on the configuration information. The WTRU may (e.g., in action 1) determine the RG size (N_{symb}) associated with a (e.g., each) FRG/DFT,

$${N}_{Symb} = \frac{{N}_{DFT}^{sc}}{{N}_{Mux}^{DFT}} .$$

The WTRU may (e.g., in action 2) determine the number of RGs per CCE,

$${N}_{RG}^{CCE} = \frac{CCE size}{{N}_{Symb}} .$$

The WIRU may perform actions 3 through 6 as described herein.

A WTRU may be provided with configuration information (e.g., configuration parameters) that may include at least one of a number of RGs multiplexed in the time domain per

$$FRG ( {N}_{Mux}^{DFT} ) ,$$

a number of RGs per

$$CCE ( {N}_{RG}^{CCE} ) ,$$

a number of FRGs (e.g., DFTs) and/or their sizes

$$( {N}_{DFT}^{sc} ) ,$$

an indication of the application of time domain multiplexing, an indication of time domain interleaving and/or its interleaving size, or an indication of frequency domain interleaving and/or its interleaving size. The configuration may be received as part of a CORESET configuration. The WTRU may perform one or more of the following actions based on the configuration information. The WTRU may (e.g., in action 1) determine an RG size (N_{Symb}) associated with a (e.g., each) FRG/DFT,

$${N}_{Symb} = \frac{{N}_{DFT}^{sc}}{{N}_{Mux}^{DFT}} .$$

The WTRU may (e.g., in action 2) determine the CCE size,

$$CCE size = {N}_{RG}^{CCE} \times {N}_{Symb} .$$

The WTRU may perform actions 3 through 6 as described herein.

Downlink (DL) control channel related configuration information may be adapted based on one or more of WTRU complexities or capabilities (e.g., including power saving criteria), network energy efficiency, channel characteristics, and/or control channel congestion conditions. For example, the DL control channel related configuration information may be adapted if the WTRU receives configuration information associated with a search space and/or a CORESET (e.g., for monitoring a PDCCH) and determines that a power consumption overhead associated with utilizing multiple IDFT modules based on the received configuration may or may not be tolerated for a period of time. The DL control channel related configuration information may be adapted if the WTRU is looking for a coverage extension or if channel characteristics have been changed significantly (e.g., due to blockage or change in orientation). In some examples, a network may trade energy efficiency for a reduction in control channel congestion, for example, by reducing in a CCE aggregation level to accommodate more control channels, while utilizing multiple smaller DFTs to enable higher precoding granularity. The DL control channel configuration adaptation may be based on measurement reporting and/or an indication of a preferred configuration (e.g., from a list of signaled and/or predefined configurations) from the WTRU.

In some examples, the WTRU may (e.g., in a first action) use a first configuration of a search space and/or a CORESET (e.g., received via an RRC message and/or system information) to monitor for a PDCCH and/or receive DCI. The WTRU may (e.g., in a second action) perform channel measurements (e.g., including one or more of a received signal strength, a coherence bandwidth, a coherence time, a delay spread, and/or a Doppler spread). The WTRU may (e.g., in a third action) determine a first condition on the measurements and/or a second condition on power consumption. The WTRU may (e.g., in a fourth action) transmit an indication of a preferred configuration (e.g., a second configuration) of a search space and/or a CORESET, and may (e.g., in a fifth action) receive a configuration (e.g., a third configuration) of a search space and/or a CORESET to monitor for the PDCCH and/or receive DCI.

In some examples, a first configuration of a search space and/or a CORESET may be a default configuration that may be independent of a WTRU's capabilities and/or existing (or prior) channel conditions. For example, the first configuration may be determined based on a pdcch-ConfigSIB1 (e.g., which may indicate a common search space and/or a CORESET #0) received via MIB and/or a PDCCH-ConfigCommon in BWP-DownlinkCommon received via SIB1. In some examples, the first configuration of a search space and/or a CORESET may be received in response to a WTRU reporting of the WTRU's capabilities. For example, the first configuration may be determined based on a PDCCH-Config (e.g., which may configure WTRU-specific PDCCH parameters such as controlResourceSet) in BWP-DownlinkDedicated received via an RRCSetup, RRCResume, and/or RRCReconfiguration message.

The WTRU capability information may include one or more parameters as described herein. The one or more parameters may be indicated to the network (e.g., a base station) explicitly and/or as an index to a set/tuple of values at the WTRU and/or the network. The one or more parameters may be indicated to the network, for example, as a set of one or more indices, where each index may indicate a set/tuple of the values. For example, the WTRU may report (e.g., explicitly) to the network a set of tuples in the following format

$$\{ ( {N}_{FRG} , {N}_{DFT}^{sc} , {N}_{pdcch}^{candidates} ) \} ,$$

e.g., {(1, 120,10), (2, 60, 10), . . . }. The WTRU may report a set of indices, e.g., {s₁, s₂, . . . }, where the first index, s₁, may be used to indicate a first tuple of values, such as, e.g.,

$$( {N}_{FRG} = 1 , {N}_{DFT}^{sc} = 1 \; 20 , {N}_{pdcch}^{candidates} = 10 ) ,$$

and the second index, s₂, may be used to indicate a second tuple of values, such as, e.g.,

$$( {N}_{FRG} = 2 , {N}_{DFT}^{sc} = 60 , {N}_{pdcch}^{candidates} = 10 ) .$$

A mapping between the indices values and the tuples may be known at the WTRU and/or the network.

In some examples, the first configuration (e.g., a default configuration) of a search space and/or a CORESET may be dependent on one or more parameters that may indicate a channel status between the WTRU and the network. The parameters may be signaled by the WTRU to the network in one or more measurement reports. The parameters may include or indicate (e.g., explicitly or implicitly) one or more of a received signal strength measurement, a coherence bandwidth, a coherence time, a delay spread, or a Doppler spread.

In some examples, the first configuration may include a configuration of measurements to be performed by the WTRU for the evaluation of a search space and/or CORESET configuration adaptation condition. The measurement configuration may be received in an RRC message, such as, e.g., a RRCReconfiguration and/or RRCResume message. The measurement configuration may be provided as part of system information, such as, e.g., as part of SIB2 or SIB11 if/when the WTRU is in an RRC IDLE/INACTIVE state. The measurement configuration may include one or more indications of evaluation conditions and/or corresponding threshold values (e.g., adaptation indication criteria). The evaluation conditions and/or corresponding threshold values (e.g., adaptation indication criteria) may be preconfigured for the WTRU (e.g., known at the WTRU).

In some examples, a WTRU may receive an indication of activation/deactivation (e.g., enablement/disablement) of a search space and/or a CORESET configuration adaptation in an L1 message (e.g., a DCI) and/or an RRC message (e.g., an RRCReconfiguration message). For example, the WTRU may receive a DCI indicating deactivation (e.g., disablement) of search space and/or CORESET adaptation. For example, the WTRU may receive an RRCReconfiguration message indicating the activation of search space and/or CORESET adaptation. The RRCReconfiguartion message may include an update of a measurement configuration and/or adaptation indication criteria.

In some examples, a first condition on measurements may evaluate a measurement of a received signal strength against a first threshold and/or a second threshold. For example, a WTRU may determine that a received signal strength is below a first threshold, and may transmit an indication of a second configuration that may enable precoding with a finer granularity. As another example, the WTRU may determine that a received signal strength is above a second threshold, and may transmit an indication of a second configuration that may enables precoding with a coarse granularity.

In some examples, a first condition on measurements may evaluate a measurement of channel coherence bandwidth (e.g., and/or delay spread) against a third threshold. For example, a WTRU may determine that a coherence bandwidth is above the third threshold, and may transmit an indication of a second configuration for a long CORESET format (e.g., to support higher mobility). The WTRU may (e.g., based on the determined high coherence bandwidth) determine that it may not benefit from the frequency diversity provided by the DFT spreading, and may select a different CORESET format (e.g., a long format) that may provide more time resources than frequency resources to enable the WTRU to benefit from time domain diversity (e.g., due to shorter coherence time at high mobility).

In some examples, a first condition on measurements may evaluate jointly a measurement of a received signal strength and a measurement of channel coherence bandwidth (e.g., and/or delay spread). For example, a transmission of an indication of a second configuration of a long CORESET format may be made based on a determination that a received signal strength is below the first threshold and/or that the coherence bandwidth is above the third threshold. One or more of the thresholds may be preconfigured at the WTRU or signaled to the WTRU via an L1 message, a MAC-CE, an RRC message, and/or system information.

The first condition described herein may be considered jointly with a second condition associated with a WTRU's power status (e.g., power consumption), battery status, and/or power saving preference. The second condition may evaluate the WTRU's power status against one or more threshold values. In an example, the WTRU may determine that an overall power consumption is above a first threshold and may transmit an indication of a preference for a second configuration for a smaller CORESET size (e.g., in terms of the number of allocated frequency resources), a smaller number of DFTs, and/or a smaller number of PDCCH candidates. In some examples, the second condition may evaluate a battery status against a second threshold. In some examples, the second condition may be considered independently of the first condition and/or may be used to activate/deactivate a DFT-s-OFDM based PDCCH (e.g., to revert to an OFDM based PDCCH design/implementation). One or more of the threshold values described herein may be (pre) configured at the WTRU and/or signaled to the WTRU via an L1 message, a MAC-CE, an RRC message, and/or system information.

In some examples, an indication of a preferred second configuration may comprise an explicit signaling of one or more updated parameters of a first configuration. For example, the indication may be an index to a configuration from one or more configurations that may be known to (e.g., preconfigured at) the WTRU and/or the network. In some examples, the indication may be an index to a configuration from one or more configurations that may be signaled (e.g., from the network) to the WTRU in an RRC message and/or via system information. In some examples, the indication of the preferred second configuration may be sent by the WTRU in an L1 message (e.g., UL control information via the PUCCH and/or PUSCH), a UL MAC-CE, and/or a UL RRC message.

In some examples, the third configuration described herein may be received in a DCI and/or an RRC message (e.g., RRCReconfiguration) and may be applied for the monitoring of subsequent PDCCH occasions (e.g., in a subsequent slot, subframe, frame, or DRX cycle). In some examples, the third configuration may be the same as the indicated second configuration. For example, the third configuration may comprise parts (e.g., one or more parameter values) of the indicated second configuration.

In some examples, a WTRU may (e.g., in a first action) use a first configuration of a search space and/or a CORESET to monitor for a PDCCH and/or DCI. The first configuration may be received in an RRC message and/or via system information. The WTRU (e.g., in a second action) may perform channel measurements, which may include one or more of a received signal strength, a coherence bandwidth, a coherence time, a delay spread, or a Doppler spread. The WTRU may (e.g., in a third action) transmit a measurement report, which may include channel state information and/or a power status. The WTRU may (e.g., in a fourth action) receive a second configuration of a search space and/or a CORESET to monitor for the PDCCH and/or receive DCI.

The WTRU may perform the measurement based on a measurement configuration received in an RRC message (e.g., measConfig in RRCReconfiguration or RRCResume, and/or MeasIdleConfig in RRCRelease) and/or via system information (e.g., MeasIdleConfigSIB in SIB11). The measurement configuration may include parameters that may configure the measurements of a received signal strength, a coherence bandwidth, a coherence time, a delay spread, or a Doppler spread. The measurements may be reported as part of channel state information. The measurement report transmission may be periodic, e.g., according to the received measurement configuration. For example, a measurement report transmission may be triggered by events that may be configured as part of the received measurement configuration. The triggering events may be determined by the WTRU, for example, as a first condition on the measurements and/or a second condition on power status (e.g., as described herein). The measurement report transmission may be triggered (e.g., alternatively and/or additionally) by a request received from the network in an L1 message (e.g., a DCI) and/or a MAC-CE. The measurement report may be transmitted by the WTRU, for example, in an L1 message (e.g., UL control information via the PUCCH or PUSCH), a UL MAC-CE, and/or a UL RRC message.

In some examples, the second configuration determined based on the transmitted measurement report may be received in an L1 mesage (e.g., a DCI) and/or an RRC message (e.g., RRCReconfiguration). The second configuration may be applied for the monitoring of subsequent PDCCH occasions (e.g., in a subsequent slot, subframe, frame, and/or DRX cycle). The search space and/or CORESET configuration described herein may include one or more parameters as described herein. A DL control channel configuration may be determined according to one or more examples described herein.

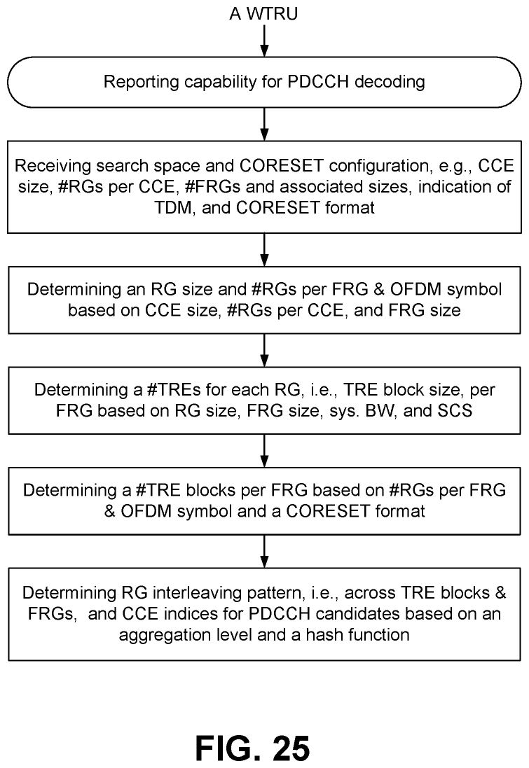

As described herein, a WTRU may receive a DL control channel transmission based on configuration information associated with a search space, a CORESET, and/or a control channel and/or by using time domain multiplexed (or time divisional multiplexed) resource groups and/or CCEs. FIG. 25 illustrates example actions that may be taken by the WTRU. For example, the WTRU may perform one or more of the actions to determine configuration information for decoding a PDCCH transmission (e.g., a PDCCH candidate) based on time division multiplexing (TDM) (which may also be referred to as time domain multiplexing). As shown in FIG. 25, the WTRU may report, to a network device, WTRU capability information associated with PDCCH decoding. The reported capability information may include, for example, a number of locally available DFT modules and/or the sizes supported by those modules. The WTRU may receive configuration information (e.g., search space and/or CORESET configuration information) that may include one or more of the following: a CCE size, a number of RGs per CCE, a number of FRGs (e.g., DFTs) and their sizes, an indication of time domain multiplexing (e.g., an indication of the application of TDM), or a CORESET format. The WTRU may determine resource group (RG) size(s) and a number of RGs multiplexed per FRG and/or OFDM symbol based on the configuration information (e.g., based on one or more of the configured CCE size, number of RGs per CCE, or FRG size(s). The WTRU may determine a number of TREs associated with a RG, such as, e.g., a TRE block size within a FRG, based on one or more of the RG size(s) or FRG size(s), a system bandwidth, or a subcarrier spacing. The WTRU may determine a number of TRE blocks within a FRG based on the number of RGs per FRG and/or OFDM symbol, and/or the CORESET format. The WTRU may determine an RG allocation pattern (e.g., RG allocation pattern information) and/or an RG interleaving pattern in a search space or CORESET (e.g., across TRE blocks and FRGs), which may indicate respective locations of the RGs in the search space or CORESET. The WTRU may determine CCE indices corresponding to a PDCCH transmission or candidate based on one or more of an aggregation level, a CORESET format, or a hash function (e.g., a pre-configured hash function). While references may be made herein to techniques associated with an allocation pattern or an interleaving pattern, such techniques may also be applicable to the other patterns (e.g., techniques disclosed herein that may be associated with an interleaving pattern may be applicable to an allocation pattern, and vice versa).

The WTRU capability information described herein may include a maximum number of PDCCH candidates supported by the WTRU and/or a maximum number of non-overlapped CCEs supported per slot or serving cell. The WTRU may determine the RG size of a CCE as the ratio of the configured CCE size to the configured number of RGs per CCE. The WTRU may determine the number of RGs multiplexed per FRG and/or OFDM symbol as the ratio of the configured FRG size to the determined RG size. The WTRU may determine the number of TREs associated with each RG in an FRG as the product of the RG size and a ratio of an IFFT module size to a DFT module size, where the DFT module size may correspond to the FRG size, and the IFFT module size may correspond to the number of subcarriers in an OFDM system with a certain system bandwidth and a certain subcarrier spacing. The WTRU may determine the number of TRE blocks, within a FRG, as the product of the determined number of RGs per FRG and/or OFDM symbol and the number of OFDM symbols allocated for DCI (e.g., as determined by the CORESET format). The WTRU may determine the aggregation level according to an indicated maximum aggregation level in the configured search space. The pre-configured hash function may be as defined in Equation (1).

The configuration information received by the WTRU may include a CORESET format indicative of one or more of a number of OFDM symbols for a DCI, a number of OFDM symbols for a DMRS, a total number of OFDM symbols for a DCI and a DMRS, OFDM symbol indices for a DCI, or OFDM symbol indices for a DMRS. The CORESET format may include frequency domain configuration information that indicative of an RE/RB mapping pattern for DMRSs and DMRS sequence parameters. The CORESET format may include an indication of one or more of a time domain interleaving, a frequency domain interleaving, a time domain interleaving size, or a frequency domain interleaving size. The CORESET format may include a precoding granularity (e.g., as a FRG-level granularity and/or a CORESET-level granularity). The WTRU may determine the RG allocation pattern across TRE blocks and FRGs based on one or more of the number of time-domain multiplexed RGs per FRG, the number of TRE blocks, the number of FRGs, the number of OFDM symbols for a DCI, the time domain interleaving size, or the frequency domain interleaving size.

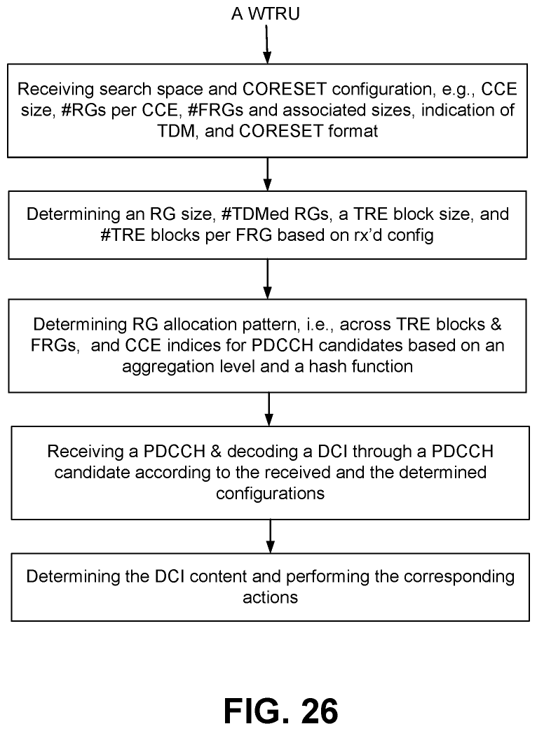

FIG. 26 illustrates example actions that may be taken by a WTRU. For example, the WTRU may take one or more of the actions illustrated in FIG. 26 to determine configuration information associated with decoding a PDCCH transmission or candidates based on TDM. As shown in FIG. 26, the WTRU may receive search space and/or CORESET configuration information, which may include on or more of the following: a CCE size, a number of RGs/CCE, a number/size of FRGs, an indication of TDM (e.g., an indication of the application of TDM), and/or a CORESET format. The WTRU may determine an RG size, a corresponding number of time division multiplexed RGs, a TRE block size, and/or a total number of TRE blocks per FRG based on the received configuration information. The WTRU may determine an RG allocation pattern in a search space or CORESET (e.g., across TRE blocks and FRGs) based on the CORESET format and/or other parameters indicated by the configuration information. The WTRU may determine one or more CCE indices for a (e.g., each) PDCCH transmission or candidate, for example, based on an aggregation level and/or a pre-configured hash function. The WTRU may receive the PDCCH transmission and/or decode the DCI in the PDCCH transmission based on the received and/or determined configuration parameters. The WTRU may determine the DCI content and/or perform a corresponding action in accordance with the DCI content.

The reception of the PDCCH transmission may include one or more of the following. The WTRU may perform an IDFT on the FRGs and/or TREs (e.g., OFDM symbols) that may be associated with the PDCCH transmission based on or more of the determined CCE indices, the number of RGs per CCE, and/or the RG allocation pattern. The WTRU may extract information carried in the TRE blocks (e.g., associated with the RGs used to transmit the PDCCH transmission) based on the determined RG size and/or the RG allocation pattern. The WTRU may demodulate the symbols received over the RGs that may be associated with the PDCCH transmission, detect a DCI format, and/or decode the DCI.

In examples, the DCI content may include downlink resource scheduling information and the corresponding action taken by the WTRU may include a reception of a PDSCH based on downlink resources assigned via the scheduling information. In examples, the DCI content may include an uplink grant or resource scheduling information, and the corresponding action taken by the WTRU may include a transmission of a PUSCH on uplink resources assigned via the grant or scheduling information. In examples, the DCI content may include an indication of a slot format and/or the corresponding action taken by the WTRU may include a determination of the slot format.

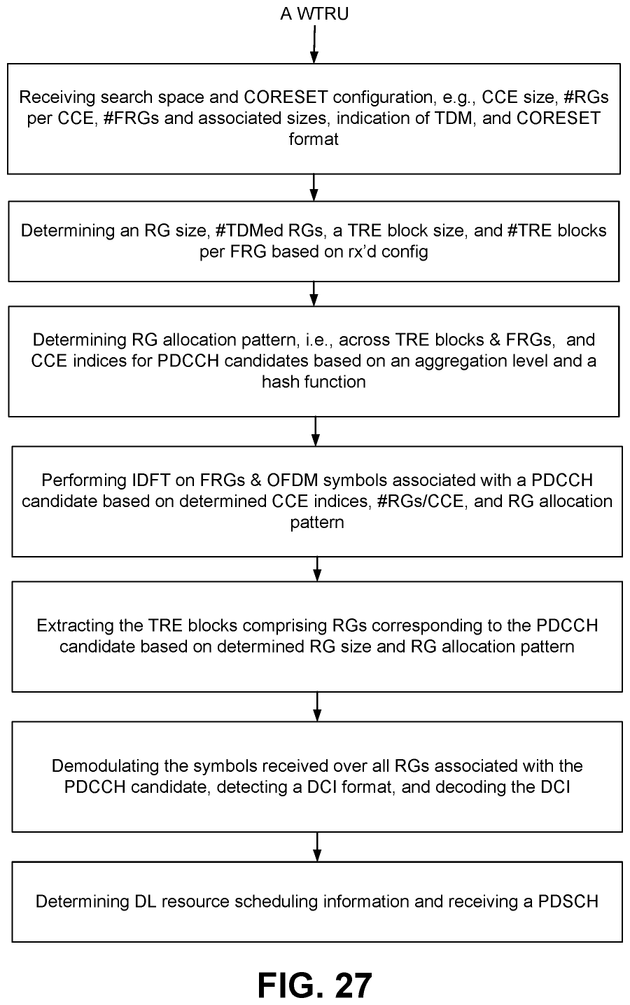

FIG. 27 illustrates example actions that may be taken by a WTRU. For example, the WTRU may perform one or more of the actions to determine configuration information associated with decoding a PDCCH candidate or transmission based on TDM. As shown in FIG. 27, the WTRU may receive search space and/or CORESET configuration information, which may include one or more of the following: a CCE size, a number of RGs/CCEs, a number/size of FRGs, an indication of TDM (e.g., the application of TDM), and/or a CORESET format. The WTRU may determine an RG size, a corresponding number of time division multiplexed RGs, a TRE block size, and/or a total number of TRE blocks per FRG based on the received configuration information. The WTRU may determine an RG allocation pattern in a search space or CORESET (e.g., across TRE blocks and FRGs) based on the CORESET format and/or other parameters indicated by the configuration information. The WTRU may determine one or more CCE indices for a PDCCH candidate or transmission based on an aggregation level and/or a pre-configured hash function. The WTRU may perform an IDFT on the FRGs and/or TREs (e.g., OFDM symbols) that may be associated with a PDCCH candidate or transmission based on one or more of the determined CCE indices, the number of RGs/CCEs, and/or the RG allocation pattern. The WTRU may extract information from the TRE blocks associated with the RGs used to transmit the PDCCH candidate or transmission based on the determined RG size and/or RG allocation pattern. The WTRU may demodulate the symbols received in the RGs associated with the PDCCH candidate or transmission, detect a DCI format, and/or decode the DCI. The WTRU may determine DL resource scheduling information based on the decoded DCI and/or receive a PDSCH based on the scheduling information.

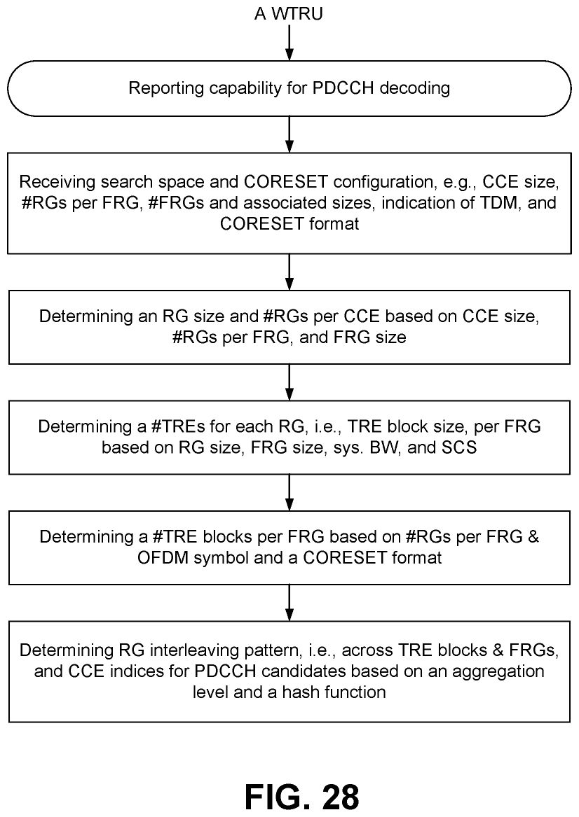

FIG. 28 illustrates example actions that may be taken by a WTRU. For example, the WTRU may perform one or more of the actions to determine configuration information associated with decoding a PDCCH candidate or transmission based on TDM. As shown in FIG. 28, the WTRU may report WTRU capability information associated with PDCCH decoding. The reported capability information may include a number of locally available DFT modules and the sizes supported by those modules. The WTRU may receive PDCCH configuration information (e.g., search space and/or CORESET configuration information) that may include one or more of the following: a CCE size, a number of RGs per FRG, a number of FRGs (e.g., DFTs) and/or their size(s), an indication of time domain multiplexing, and/or a CORESET format. The WTRU may determine RG size(s) and/or a number of RGs per CCE based on one or more of the configured CCE size, the number of RGs per FRG, and/or the FRG size(s). The WTRU may determine a number of TREs for an RG (e.g., TRE block size(s) for the RG), within an FRG, based on one or more of the RG size or FRG size, a system bandwidth, and/or a subcarrier spacing. The WTRU may determine a number of TRE blocks (e.g., within an FRG) based on the number of RGs per FRG and/or OFDM symbol, and/or based on a CORESET format. The WTRU may determine an RG allocation pattern in a search space or CORESET (e.g., across TRE blocks and/or FRGs) and/or CCE indices corresponding to a PDCCH candidate or transmission based on one or more of an aggregation level, a CORESET format, or a pre-configured hash function. The WTRU may determine the RG size of a CCE, for example, as the ratio of the configured FRG size to the configured number of multiplexed RGs per FRG. The WTRU may determine the number of RGs per CCE, for example, as the ratio of the configured CCE size to the determined RG size.

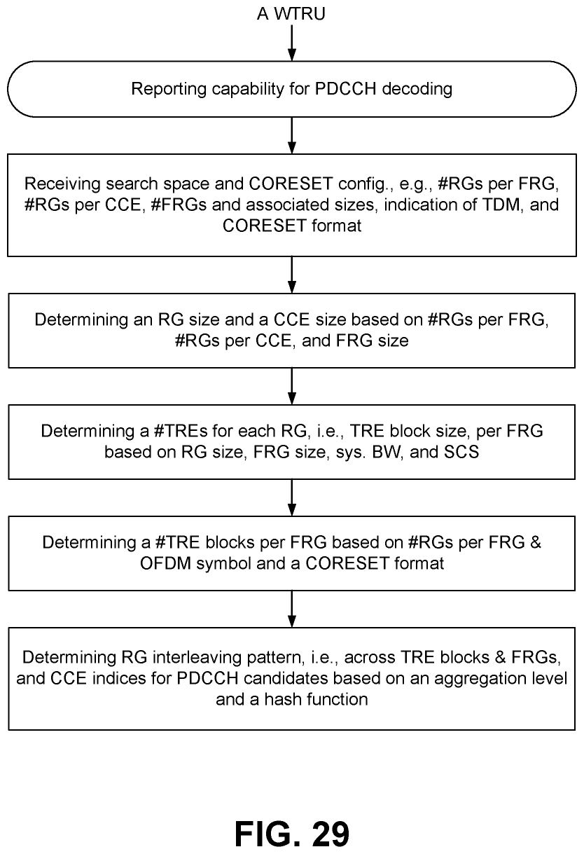

FIG. 29 illustrates example actions that may be taken by a WTRU. For example, the WTRU may perform one or more of the actions to determine configuration information associated with decoding a PDCCH candidate or transmission based on TDM. As shown in FIG. 29, the WTRU may report WTRU capability information associated with PDCCH decoding. The reported capability information may include a number of locally available DFT modules and the sizes supported by those modules. The WTRU may receive PDCCH configuration information (e.g., search space and/or CORESET configuration information) that may include one or more of the following: a number of RGs per FRG, a number of RGs per CCE, a number of FRGs (e.g., DFTs) and/or associated size(s), an indication of time domain multiplexing, and/or a CORESET format. The WTRU may determine RG size(s) and/or CCE size based on one or more of the configured number of RGs per CCE, the number of RGs per FRG, and/or the FRG size(s). The WTRU may determine a number of TREs for an RG (e.g., a TRE block size) within an FRG based on one or more of the RG size or FRG size, a system bandwidth, or a subcarrier spacing. The WTRU may determine a number of TRE blocks (e.g., within an FRG) based on the number of RGs per FRG and/or OFDM symbol, and/or based on a CORESET format. The WTRU may determine an RG allocation pattern in search space or CORESET (e.g., across TRE blocks and/or FRGs) and/or CCE indices corresponding to a PDCCH candidate or transmission based on one or more of an aggregation level, a CORESET format, and/or a pre-configured hash function. The WTRU may determine the RG size of a CCE, for example, as the ratio of the configured FRG size to the configured number of multiplexed RGs per FRG. The WTRU may determine the CCE size, for example, as the product of the number of RGs per CCE and the determined RG size.

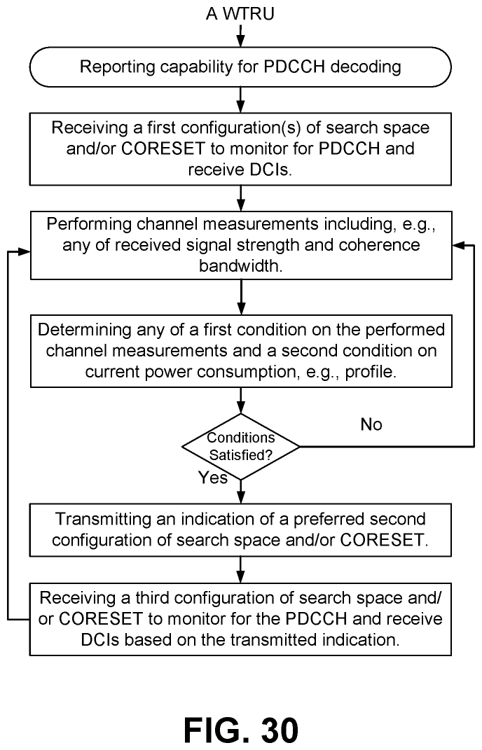

FIG. 30 illustrates example actions that may be taken by a WTRU. For example, the WTRU may perform one or more of the actions to (e.g., dynamically) update configuration information associated with decoding a PDCCH candidate or transmission based on a preferred configuration indication. As shown in FIG. 30, the WTRU may report WTRU capability information associated with PDCCH decoding. The reported capability information may include a number of locally available DFT modules and the sizes supported by those modules. The WTRU may receive first configuration information associated with a search space and/or a CORESET to monitor for a PDCCH and/or receive DCI. The WTRU may perform one or more channel measurements, which may include one or more of a received signal strength, a coherence bandwidth, a coherence time, a delay spread, or a Doppler spread. The WTRU may determine one or more of a first condition associated with the performed channel measurements and/or a second condition associated with a current power consumption. The WTRU may (e.g., if one or more of the first or second condition are satisfied) transmit an indication of a preferred second configuration associated with a search space and/or a CORESET. The WTRU may receive third configuration information indicative of a search space and/or a CORESET to monitor for a PDCCH transmission and/or receive DCI.

The WTRU capability may include one or more of the following: a number of FRGs, one or more FRG size(s), and/or a number of supported PDCCH candidates, which may be reported (e.g., explicitly) to the network and/or reported as an index to a set or a tuple of known values at the WTRU and/or the network. The first configuration of the search space and/or CORESET may be a default configuration (e.g., independent of WTRU capability and/or existing or prior channel conditions) that may be determined based on a received ConfigSIB1 (e.g., via MIB) and/or a received PDCCH-ConfigCommon (e.g., in BWP-DownlinkCommon of SIB1). The first configuration of the search space and/or CORESET may be received in response to a WTRU capability report and/or may be determined based on a PDCCH-Config (e.g., in BWP-DownlinkDedicated) received in one or more of an RRCSetup message, an RRCResume message, or an RRCReconfiguration message. The first configuration of the search space and/or CORESET may indicate a configuration of channel measurements for the evaluation of the search space and/or CORESET configuration adaptation conditions. The WTRU may receive the configuration of the channel measurements in an RRCReconfiguration message or an RRCResume message. The WTRU may receive the configuration of the channel measurements in a system information message (e.g., in an SIB2 message and/or an SIB11 message). The configuration of the channel measurements may include one or more indications of the evaluation conditions and/or corresponding threshold values.

The WTRU may be configured to receive an indication of an activation and/or deactivation of search space and/or CORESET configuration adaptation, for example, via an L1 message (e.g., DCI) and/or an RRC message (e.g., an RRCReconfiguration message). The WTRU may transmit an indication of the second configuration (e.g., for enabling precoding with a finer granularity) based on a determination that a measurement of a received signal strength may be below a first threshold. The WTRU may transmit an indication of the second configuration (e.g., for enabling precoding with a coarse granularity) based on a determination that a measurement of a received signal strength may be above a second threshold. The WTRU may transmit an indication of the second configuration for a long CORESET format based on a determination that a measurement of a coherence bandwidth may be above a third threshold. The WTRU may transmit an indication of the second configuration for a long CORESET format based on a determination that a measurement of a received signal strength may be below a first threshold and/or that a measurement of a coherence bandwidth may be above a third threshold.

The condition on power consumption may include a condition on one or more of a current battery status, a current power consumption profile, and/or a power saving preference. The WTRU may transmit an indication of the second configuration for a smaller CORESET size (e.g., a number of allocated frequency resources, a number of DFTs, and/or a number of PDCCH candidates) based on a determination that a power consumption (e.g., an overall power consumption) may be above a first threshold. The WTRU may transmit an indication of the second configuration with which a DFT-s-OFDM based PDCCH may be deactivated (e.g., revert to an OFDM based PDCCH design) based on a determination that a battery status may be below a second threshold. The indication of the preferred second configuration may include signaling (e.g., explicit signaling) of one or more updated parameters of the first configuration. The indication of the preferred second configuration may include an index to a configuration from one or more configurations that may be known at the WTRU and/or the network. The indication of the preferred second configuration may include an index to a configuration from one or more configurations that may be signaled from the network to the WTRU (e.g., in an RRC message and/or via system information).

The WTRU may send the indication of the preferred second configuration in one or more of an L1 message (e.g., UL control information via a PUCCH and/or a PUSCH), a UL MAC-CE message, and/or a UL RRC message. The WTRU may receive the third configuration in a DCI message and/or an RRC message (e.g., RRCReconfiguration). The WTRU may apply the third configuration for the monitoring of subsequent PDCCH occasions (e.g., in a subsequent slot, subframe, frame, and/or DRX cycle). The received third configuration may include a portion or all of the indicated second configuration. The WTRU may use configuration information for decoding of a PDCCH candidate or transmission according to one or more examples described herein.

A WTRU as described herein may include a processor, and the WTRU may be configured to receive, from a network device, configuration information that may indicate at least a CCE and a plurality of resource groups associated with the CCE. Each resource group associated with the CCE may include a respective time resource element (TRE) and a respective frequency resource group (FRG), wherein each respective TRE may include a non-integer number of time units, and wherein each respective FRG may include multiple frequency units. The WTRU may be further configured to determine that the CCE may be associated with a time division multiplexed (TDMed) downlink control channel transmission, and further determine, based on the configuration information, allocation pattern information associated with the plurality of resource groups, wherein the allocation pattern information may indicate respective locations of the plurality of resource groups in a search space. The WTRU may receive the TDMed downlink control channel transmission in accordance with the allocation pattern information associated with the plurality of resource groups, and receive a downlink shared channel transmission based on information in the TDMed downlink control channel transmission.

Each respective TRE as described herein may include a non-integer number of orthogonal frequency division multiplexing (OFDM) symbols, and each respective FRG as described herein may include multiple sub-carriers (e.g., the multiple sub-carriers may be associated with a single DFT module). The WTRU being configured to receive the TDMed control channel transmission in accordance with the allocation pattern information associated with the plurality of resource groups may include the WTRU being configured to locate the respective TREs and the respective FRGs of the plurality of resource groups in the search space based on the allocation pattern information and perform an inverse discrete Fourier transform (IDFT) based on the respective TREs and the respective FRGs of the plurality of resource groups. Each respective TRE as described herein may correspond to an output sample of the IDFT.

The configuration information described herein may further indicate a CCE aggregation level, and the WTRU may be configured to determine that the CCE is associated with the TDMed downlink control channel transmission based on at least one of a hash function or the CCE aggregation level indicated by the configuration information. The configuration information may further indicate one or more of a CORESET format, a number of FRGs in the search space, a size of the FRGs in the search space, or an indication that time division multiplexing may be applied to the downlink control channel transmission.

The WTRU being configured to receive the downlink shared channel transmission based on the information in the TDMed downlink control channel transmission may include the WTRU being configured to decode DCI included in the TDMed downlink control channel transmission and determine resources for receiving the downlink shared channel transmission from the decoded DCI. The WTRU may be further configured to send a report to the network device that may indicate one or more of a number of DFT modules supported by the WTRU, a size of a DFT module, a number physical downlink control channel (PDCCH) transmissions that the WTRU may be capable of decoding in a symbol, a slot or a serving cell, or a number of non-overlapping CCEs supported by the WTRU.

A network device (e.g., a base station) as described herein may include a processor, and the network device may be configured to transmit configuration information to a wireless transmit/receive unit (WTRU), wherein the configuration information may indicate at least a CCE and a plurality of resource groups associated with the CCE. Each resource group associated with the CCE may include a respective TRE and a respective FRG. The respective TRE may include a non-integer number of time units, while the respective FRG may include multiple frequency units. The network device may be further configured to transmit a downlink control channel transmission based on TDM and using the plurality of resource groups associated with the CCE, wherein the downlink control channel transmission may include resource allocation information for a downlink shared channel transmission. The network device may further transmit the downlink shared channel transmission in accordance with the resource allocation information in the downlink control channel transmission.

Although features and elements described above are described in particular combinations, each feature or element may be used alone without the other features and elements of the preferred embodiments, or in various combinations with or without other features and elements. Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well. The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU), comprising:
a processor configured to:
receive, from a network device, configuration information that indicates at least a control channel element (CCE) and a plurality of resource groups associated with the CCE, wherein each resource group associated with the CCE includes a respective time resource element (TRE) and a respective frequency resource group (FRG), wherein each respective TRE comprises a non-integer number of time units, and wherein each respective FRG comprises multiple frequency units;
determine that the CCE is associated with a time division multiplexed (TDMed) downlink control channel transmission;
determine, based on the configuration information, allocation pattern information associated with the plurality of resource groups, wherein the allocation pattern information indicates respective locations of the plurality of resource groups in a search space;
receive the TDMed downlink control channel transmission in accordance with the allocation pattern information associated with the plurality of resource groups; and
receive a downlink shared channel transmission based on information in the TDMed downlink control channel transmission.

2. The WTRU of claim 1, wherein the respective TRE associated with each resource group includes a non-integer number of orthogonal frequency division multiplexing (OFDM) symbols, and wherein the respective FRG associated with each resource group includes multiple sub-carriers.

3. The WTRU of claim 2, wherein the multiple sub-carriers are associated with a single discrete Fourier transform (DFT) module.

4. The WTRU of claim 1, wherein the processor being configured to receive the TDMed control channel transmission in accordance with the allocation pattern information associated with the plurality of resource groups comprises the processor being configured to locate the respective TREs and the respective FRGs of the plurality of resource groups in the search space based on the allocation pattern information and perform an inverse discrete Fourier transform (IDFT) based on the respective TREs and the respective FRGs of the plurality of resource groups.

5. The WTRU of claim 4, wherein the respective TRE associated with each resource group corresponds to an output sample of the IDFT.

6. The WTRU of claim 1, wherein the configuration information further indicates a CCE aggregation level, and wherein the processor is configured to determine that the CCE is associated with the TDMed downlink control channel transmission based on at least one of a hash function or the CCE aggregation level indicated by the configuration information.

7. The WTRU of claim 1, wherein the configuration information further indicates one or more of a control resource set (CORESET) format, a number of FRGs in the search space, a size of the FRGs in the search space, or an indication that time division multiplexing is applied to the downlink control channel transmission.

8. The WTRU of claim 1, wherein the processor being configured to receive the downlink shared channel transmission based on the information in the TDMed downlink control channel transmission comprises the processor being configured to decode downlink control information (DCI) included in the TDMed downlink control channel transmission and determine resources for receiving the downlink shared channel transmission from the decoded DCI.

9. The WTRU of claim 1, wherein the processor is further configured to send a report to the network device that indicates one or more of a number of discrete Fourier transform (DFT) modules supported by the WTRU, a size of a DFT module, a number physical downlink control channel (PDCCH) transmissions that the WTRU is capable of decoding in a symbol, a slot or a serving cell, or a number of non-overlapping CCEs supported by the WTRU.

10. A method implemented by a wireless transmit/receive unit (WTRU), the method comprising:
receiving, from a network device, configuration information that indicates at least a control channel element (CCE) and a plurality of resource groups associated with the CCE, wherein each resource group associated with the CCE includes a respective time resource element (TRE) and a respective frequency resource group (FRG), wherein the respective TRE comprises a non-integer number of time units, and wherein the respective FRG comprises multiple frequency units;
determining that the CCE is associate with a time division multiplexed (TDMed) downlink control channel transmission;
determining, based on the configuration information, allocation pattern information associated with the plurality of resource groups, wherein the allocation pattern information indicates respective locations of the plurality of resource groups in a search space;
receiving the TDMed downlink control channel transmission in accordance with the allocation pattern information associated with the plurality of resource groups; and
receiving a downlink shared channel transmission based on information in the TDMed downlink control channel transmission.

11. The method of claim 10, wherein the respective TRE associated with each resource group includes a non-integer number of orthogonal frequency division multiplexing (OFDM) symbols, and wherein the respective FRG associated with each resource group includes multiple sub-carriers.

12. The method of claim 10, wherein receiving the TDMed control channel transmission in accordance with the allocation pattern information associated with the plurality of resource groups comprises locating the respective TREs and the respective FRGs of the plurality of resource groups in the search space based on the allocation pattern information and performing an inverse discrete Fourier transform (IDFT) based on the respective TREs and the respective FRGs of the plurality of resource groups.

13. The method of claim 10, wherein the configuration information further indicates a CCE aggregation level, and wherein the CCE is determined to be associated with the TDMed downlink control channel transmission based on at least one of a hash function or the CCE aggregation level indicated by the configuration information.

14. The method of claim 10, wherein the configuration information further indicates one or more of a control resource set (CORESET) format, a number of FRGs in the search space, a size of the FRGs in the search space, or an indication that time division multiplexing is applied to the downlink control channel transmission.

15. A network device, comprising:
a processor configured to:
transmit configuration information to a wireless transmit/receive unit (WTRU), wherein the configuration information indicates at least a control channel element (CCE) and a plurality of resource groups associated with the CCE, wherein each resource group associated with the CCE includes a respective time resource element (TRE) and a respective frequency resource group (FRG), wherein the respective TRE comprises a non-integer number of time units, and wherein the respective FRG comprises multiple frequency units;
transmit a downlink control channel transmission based on time division multiplexing and using the plurality of resource groups associated with the CCE, wherein the downlink control channel transmission includes resource allocation information for a downlink shared channel transmission; and
transmit the downlink shared channel transmission in accordance with the resource allocation information in the downlink control channel transmission.

16. The network device of claim 15, wherein the respective TRE associated with each resource group includes a non-integer number of orthogonal frequency division multiplexing (OFDM) symbols, and wherein the respective FRG associated with each resource group includes multiple sub-carriers that are associated with a single discrete Fourier transform (DFT) module.

17. The method of claim 10, wherein the multiple sub-carriers of each FRG are associated with a single discrete Fourier transform (DFT) module.

18. The method of claim 12, wherein the respective TRE associated with each resource group corresponds to an output sample of the IDFT.

19. The method of claim 10, wherein receiving the downlink shared channel transmission based on the information in the TDMed downlink control channel transmission comprises decoding downlink control information (DCI) included in the TDMed downlink control channel transmission and determining resources for receiving the downlink shared channel transmission from the decoded DCI.

20. The method of claim 10, further comprising sending a report to the network device that indicates one or more of a number of discrete Fourier transform (DFT) modules supported by the WTRU, a size of a DFT module, a number physical downlink control channel (PDCCH) transmissions that the WTRU is capable of decoding in a symbol, a slot or a serving cell, or a number of non-overlapping CCEs supported by the WTRU.
